(19) United States
(12) Patent Application Publication
(10) Pub. No.: US 2025/0083701 A1
(43) Pub. Date: Mar. 13, 2025

(54) ACTION PLANNING APPARATUS AND ACTION PLANNING METHOD

(71) Applicant: Mitsubishi Electric Corporation, Tokyo (JP)

(72) Inventors: Hiroshi YAMADA, Tokyo (JP); Shota KAMEOKA, Tokyo (JP)

(73) Assignee: Mitsubishi Electric Corporation, Tokyo (JP)

(21) Appl. No.: 18/726,431

(22) PCT Filed: Jan. 26, 2022
(86) PCT No.: PCT/JP2022/002926

§ 371 Date: Jul. 3, 2024

(51) Int. Cl. B60W 60/00

(52) U.S. Cl. CPC B60W 60/0011

(57) ABSTRACT

An action planning apparatus calculate, when one piece of scene information is listed by a scene generation unit, one or more modes and calculate, when a plurality of pieces of scene information are listed by the scene generation unit, a plurality of modes in parallel using the plurality of pieces of scene information. The action planning apparatus selects one of the modes calculated in the calculating step and outputs the selected one of the modes as action of a moving body.

### TECHNICAL FIELD

The present disclosure relates to action planning apparatuses and action planning methods.

### BACKGROUND ART

In recent years, autonomous driving technology has increasingly been developed, and technology of not just assisting driving of a user but performing autonomous driving without user intervention for driving operation has been highlighted. This results in the need for an action planning apparatus that acquires, when a vehicle travels in an urban area by autonomous driving, information on traffic rules, traffic lights, pedestrians, positions of the other vehicles, and speeds of the other vehicles and the like and determines action of a host vehicle.

In Patent Document 1, for example, a knowledge tree indicating the order of obstacle detection frames is used to sequentially determine whether there is an obstacle in the obstacle detection frames. This enables calculation of an appropriate degree of risk and determination of appropriate action of a host vehicle.

### PRIOR ART DOCUMENTS

### Patent Document

Patent Document 1: Japanese Patent No. 6432677

### SUMMARY

### Problem to be Solved by the Invention

The knowledge tree in Patent Document 1 is data indicating obstacle detection frames determined by a position of the host vehicle at a specific spot and the order of obstacle detection frames to which attention is to be paid for the host vehicle. The invention described in Patent Document 1 thus sequentially determines recent targets for consideration for the host vehicle one by one according to the knowledge tree and determines action of the host vehicle. The invention described in Patent Document 1 thus determines, in a composite scene in which there are a plurality of targets for consideration, such as another vehicle at an intersection and a pedestrian ready across a crosswalk, the possibility that the pedestrian moves after there is no another vehicle, so that the host vehicle is stopped for a longer time and takes more conservative action. As described above, the invention described in Patent Document 1 takes time to determine action of the host vehicle, making it difficult to increase throughput at an intersection. The present invention has been conceived to solve a problem as described above, and it is an object of the present invention to provide an action planning apparatus that avoids conservative action compared with the invention described in Patent Document 1 in a composite scene in which there are a plurality of targets for consideration when action of a host vehicle is planned, such as a scene at an intersection.

### Means to Solve the Problem

An action planning apparatus according to the present disclosure includes: a scene generation unit that generates, using surroundings information on surroundings of a moving body, one or more pieces of scene information indicating a situation in which the moving body is placed; a mode calculation unit that calculates, when one piece of scene information is generated by the scene generation unit, one or more modes as candidates for action that the moving body can take using the one piece of scene information and calculates, when a plurality of pieces of scene information are generated by the scene generation unit, a plurality of modes as candidates for action that the moving body can take in parallel using the plurality of pieces of scene information; and a mode selection unit that selects one of the modes calculated by the mode calculation unit and outputs the selected one of the modes as action of the moving body.

An action planning method according to the present disclosure includes: generating, using surroundings information on surroundings of a moving body, one or more pieces of scene information indicating a situation in which the moving body is placed; calculating, when one piece of scene information is generated, one or more modes as candidates for action that the moving body can take using the one piece of scene information and calculating, when a plurality of pieces of scene information are generated, a plurality of modes as candidates for action that the moving body can take in parallel using the plurality of pieces of scene information; and selecting one of the modes calculated in the calculating step and outputting the selected one of the modes as action of the moving body.

### Effects of the Invention

According to the present disclosure, when the plurality of pieces of scene information is generated by the scene generation unit, the plurality of modes are calculated in parallel using the plurality of pieces of scene information, and one of the modes calculated in the calculating step is selected and output as action of a host vehicle. Conservative action can thereby be avoided in a composite scene.

### BRIEF DESCRIPTION OF DRAWINGS

FIG. 1 is a block diagram showing a portion of a host vehicle including an action planning apparatus according to Embodiment 1.

FIG. 2 is a schematic diagram showing examples of a hardware configuration of the action planning apparatus according to Embodiment 1.

FIG. 3 is a flowchart showing an action planning method according to Embodiment 1.

FIG. 4 is a schematic diagram illustrating a situation in which the host vehicle according to Embodiment 1 is placed.

FIG. 5 is a diagram showing pieces of scene information generated by a scene generation unit according to Embodiment 1.

FIG. 6 is a schematic diagram showing a first mode calculation unit according to Embodiment 1.

FIG. 7 is a schematic diagram showing a second mode calculation unit according to Embodiment 1.

FIG. 8 is a diagram showing transition conditions of the first mode calculation unit according to Embodiment 1.

FIG. 9 is a diagram showing transition conditions of the second mode calculation unit according to Embodiment 1.

FIG. 10 is a schematic diagram illustrating action of the host vehicle including the action planning apparatus according to Embodiment 1.

FIG. 11 is a diagram showing examples of results of output of respective components of the action planning apparatus according to Embodiment 1.

FIG. 12 is a diagram showing operation of the action planning apparatus according to Embodiment 1 in a time sequence.

FIG. 13 is a diagram showing operation of an action planning apparatus according to a comparative example of Embodiment 1 in a time sequence.

FIG. 14 is a block diagram showing a portion of a host vehicle including an action planning apparatus according to Embodiment 2.

FIG. 15 is a flowchart showing an action planning method according to Embodiment 2.

FIG. 16 is a schematic diagram showing action of the host vehicle including the action planning apparatus according to Embodiment 2.

FIG. 17 is a diagram showing pieces of scene information generated by a scene generation unit according to Embodiment 2.

FIG. 18 is a schematic diagram showing a first mode calculation unit according to Embodiment 2.

FIG. 19 is a diagram showing transition conditions of the first mode calculation unit according to Embodiment 2.

FIG. 20 is a diagram showing examples of results of output of respective components of the action planning apparatus according to Embodiment 2.

FIG. 21 is a diagram showing operation of the action planning apparatus according to Embodiment 2 in a time sequence.

FIG. 22 is a diagram showing operation of an action planning apparatus according to a comparative example of Embodiment 2 in a time sequence.

FIG. 23 is a schematic diagram illustrating a situation in which a host vehicle according to Embodiment 3 is placed.

FIG. 24 is a diagram showing examples of results of output of respective components of an action planning apparatus according to Embodiment 3.

### DESCRIPTION OF EMBODIMENTS

### Embodiment 1

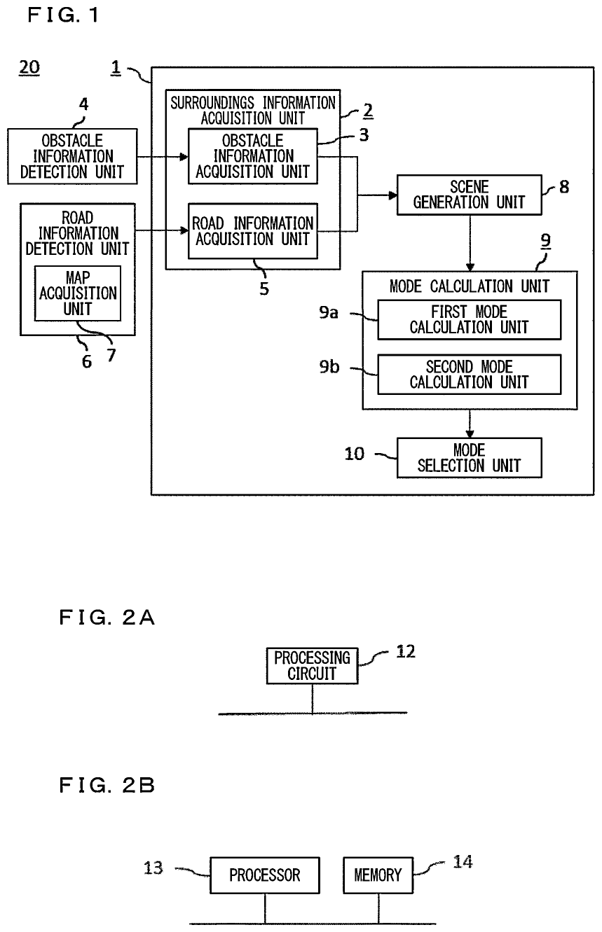

An action planning apparatus 1 according to Embodiment 1 will be described with reference to FIG. 1. FIG. 1 is a block diagram showing a portion of a host vehicle 20 including the action planning apparatus 1 according to Embodiment 1. The action planning apparatus 1 is an apparatus that plans action of the host vehicle 20 and includes a surroundings information acquisition unit 2, a scene generation unit 8, a mode calculation unit 9, and a mode selection unit 10. An example in which the host vehicle 20 is an automobile will be described in the present embodiment.

The surroundings information acquisition unit 2 includes an obstacle information acquisition unit 3 and a road information acquisition unit 5. The obstacle information acquisition unit 3 acquires, from an obstacle information detection unit 4, information on an obstacle present around the host vehicle 20. The road information acquisition unit 5 acquires, from a road information detection unit 6, information on a road around the host vehicle 20. The information on the obstacle present around the host vehicle 20 detected by the obstacle information detection unit 4 and the information on the road around the host vehicle 20 are hereinafter respectively referred to as obstacle information and road information. The surroundings information acquisition unit 2 acquires surroundings information as a general term for the obstacle information and the road information.

The surroundings information acquisition unit 2 may not necessarily be included in the action planning apparatus 1. For example, in remote control of the host vehicle 20 performed by a controller, the surroundings information acquisition unit 2 and components other than the surroundings information acquisition unit 2 (the scene generation unit 8, the mode calculation unit 9, and the mode selection unit 10) can be provided separately. Specifically, the surroundings information acquisition unit 2 is provided in the host vehicle 20, and the components other than the surroundings information acquisition unit 2 are provided as the action planning apparatus 1 on a controller side. A configuration is not limited to this configuration, and the reverse may take place, for example.

The obstacle information detection unit 4 detects the obstacle information. An example of the obstacle includes a traffic participant, such as another vehicle 21, a pedestrian 22, a bicycle, and a motorcycle present around the host vehicle 20. The obstacle information detection unit 4 is at least one of a camera, a radar, a LiDAR, and a sonar sensor mounted on the host vehicle 20, for example. The obstacle information detection unit 4 may also be at least one of a camera, a radar, a LiDAR, and a sonar sensor mounted not on the host vehicle 20 but on an infrastructure side, for example. When the obstacle information detection unit 4 is mounted on the infrastructure side, the obstacle information acquisition unit 3 acquires the obstacle information by wireless communication with the obstacle information detection unit 4. The obstacle information detection unit 4 may output, to the obstacle information acquisition unit 3, the obstacle present around the host vehicle 20 as obstacle information associated with a type classified into the other vehicle 21, the pedestrian 22, the bicycle, the motorcycle, or the like.

The road information detection unit 6 detects the road information. The road information detection unit 6 detects traffic lights that the host vehicle 20 is to comply with, a lighting state of the detected traffic lights, a road sign, and the like. The road information detection unit 6 is at least one of a camera, a radar, a LiDAR, and a sonar sensor mounted on the host vehicle 20, for example. The road information detection unit 6 may also be at least one of a camera, a radar, a LiDAR, and a sonar sensor mounted not on the host vehicle 20 but on the infrastructure side, for example. When the road information detection unit 6 is mounted on the infrastructure side, the road information acquisition unit 5 acquires the road information by wireless communication with the road information detection unit 6.

The road information detection unit 6 may include a map acquisition unit 7. The map acquisition unit 7 acquires map data of a planned travel path of the host vehicle 20 and outputs the acquired map data as the road information to the road information acquisition unit 5. Examples of the map data include a centerline of a lane in which the host vehicle 20 travels, information on a stop line at an intersection, preferential road information, and non-preferential road information.

The map acquisition unit 7 acquires the map data of the planned travel path of the host vehicle 20 in advance and identifies a position of the host vehicle 20 on the map data using information acquired from at least one of the camera, the radar, the LiDAR, and the sonar sensor. The map acquisition unit 7 outputs the road information on the surroundings of the host vehicle 20 to the road information detection unit 6. Alternatively, the map acquisition unit 7 may sequentially acquire pieces of map data on a travel path around the host vehicle 20 and output the road information on the surroundings of the host vehicle 20 to the road information detection unit 6.

The host vehicle 20 may include a GNSS sensor to identify the position of the host vehicle 20, and the obstacle information detection unit 4 and the road information detection unit 6 may output information using a relative coordinate system relative to the position of the host vehicle 20 or may output information using an absolute coordinate system relative to a specific spot when outputting information to the surroundings information acquisition unit 2.

The scene generation unit 8 generates one or more pieces of scene information indicating a situation in which the host vehicle 20 is placed using the surroundings information acquired by the surroundings information acquisition unit 2. Detailed operation of the scene generation unit 8 will be described below.

The mode calculation unit 9 calculates, using the one or more pieces of scene information generated by the scene generation unit 8, one or more modes as candidates for action that the host vehicle 20 can take. The action that the host vehicle 20 can take is action to be taken by the host vehicle 20 currently or into the future. The action that the host vehicle 20 can take includes traveling along a path along which the host vehicle 20 is currently traveling as it is, being stopped at a specific position on the path, and the like. The action planning apparatus 1 includes a plurality of mode calculation units 9. The plurality of mode calculation units 9 calculate one or more modes when one piece of scene information is generated by the scene generation unit 8 and calculate a plurality of modes in parallel when a plurality of pieces of scene information are generated by the scene generation unit 8. Specifically, a mode is information indicating at least one of a target path, a target speed, and a target position. The mode calculation unit 9 may set values of the target path, the target speed, and the target position in advance for each mode and may dynamically change the values depending on the mode and an environment around the host vehicle 20. For example, the mode calculation unit 9 may calculate the target speed for each movement amount of the host vehicle 20. The mode calculated by the mode calculation unit 9 is not limited to that described above and may be information indicating maximum and minimum acceleration, a steering angle, a lane number for lane change, and the like. Detailed operation of the mode calculation unit 9 will be described below.

The mode selection unit 10 selects one of the one or more modes calculated by the plurality of mode calculation units 9 and outputs the selected one of the modes as action of the host vehicle 20. That is to say, when one piece of scene information is generated by the scene generation unit 8 and only one mode is calculated or when the modes calculated by the plurality of mode calculation units 9 are of one type, the mode selection unit 10 outputs the mode as the action of the host vehicle 20. When the plurality of mode calculation units 9 calculate a plurality of modes that are different from each other, the mode selection unit 10 selects one of the plurality of modes calculated by the plurality of mode calculation units 9 using degrees of priority of the modes set in advance and outputs the selected one of the modes as the action of the host vehicle 20. The degrees of priority are set to give priority to a mode to address an obstacle, for example. When there are a plurality of modes to address an obstacle, the degrees of priority are set to give priority to a mode to address a higher risk that can occur due to an obstacle. The action planning apparatus 1 can thereby avoid the risk that can occur due to the obstacle. Detailed operation of the mode selection unit 10 will be described below.

Examples of a hardware configuration of the action planning apparatus 1 will be described next. FIG. 2 is a schematic diagram showing examples of the hardware configuration of the action planning apparatus 1 according to Embodiment 1. Each of the components of the action planning apparatus 1 may be a processing circuit 12 as dedicated hardware as shown in FIG. 2A or may be a processor 13 that executes a program stored in memory 14 as shown in FIG. 2B.

When each of the components of the action planning apparatus 1 is the dedicated hardware as shown in FIG. 2A, the processing circuit 12 corresponds to a single circuit, a composite circuit, a programmed processor, a parallel programmed processor, an application specific integrated circuit (ASIC), a field-programmable gate array (FPGA), or a combination thereof, for example. Functions of the components of the action planning apparatus 1 may be achieved by respective processing circuits 12 or may collectively be achieved by a single processing circuit 12.

When each of the components of the action planning apparatus 1 is the processor 13 as shown in FIG. 2B, the functions of the components are achieved by software, firmware, or a combination of software and firmware. Software or firmware is described as a program and stored in the memory 14. The processor 13 reads and executes the program stored in the memory 14 to achieve the functions of the components of the action planning apparatus 1. That is to say, the components of the action planning apparatus 1 include the memory 14 to store the program which, when executed by the processor 13, results in performance of steps of a light distribution control method according to each embodiment described below. It can be said that the program causes a computer to execute procedures or methods of the components of the action planning apparatus 1.

The processor 13 herein refers to a central processing unit (CPU), a processing unit, an arithmetic unit, a processor, a microprocessor, a microcomputer, a digital signal processor (DSP), and the like, for example. The memory 14 herein may be, for example, nonvolatile or volatile semiconductor memory, such as random access memory (RAM), read only memory (ROM), flash memory, erasable programmable ROM (EPROM), and electrically EPROM (EEPROM), or may be a magnetic disk, such as a hard disk and a flexible disk, or an optical disc, such as a mini disc, a compact disc (CD), and a digital versatile disc (DVD).

One or more of the functions of the components of the action planning apparatus 1 may be achieved by dedicated hardware, and other one or more of the components may be achieved by software or firmware. As described above, the processing circuit 12 of the action planning apparatus 1 can achieve the above-mentioned functions by hardware, software, firmware, or a combination of them.

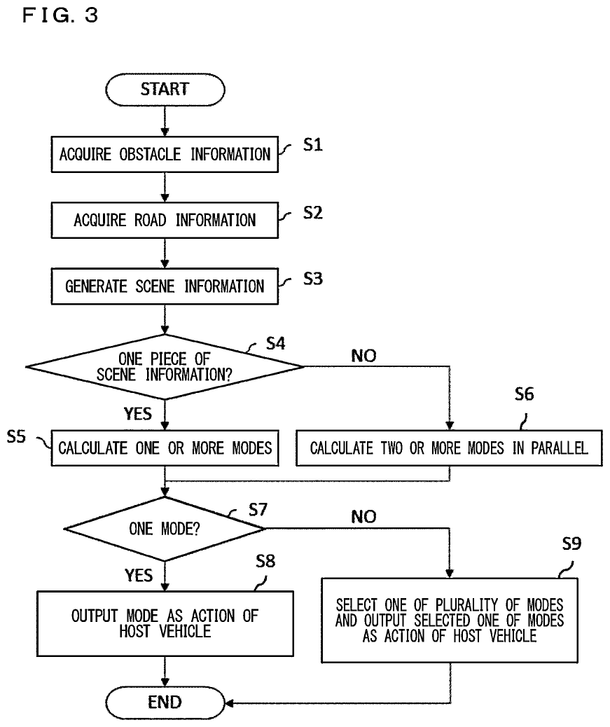

An action planning method performed by the action planning apparatus 1 will be described next. FIG. 3 is a flowchart showing the action planning method according to Embodiment 1. Processing operation in the flowchart of FIG. 3 is repeatedly performed during travel of the host vehicle 20. In the present embodiment, description will be made based on an assumption that a period from START to END shown in FIG. 3 is one calculation period.

In Step S1 and Step S2, the surroundings information acquisition unit 2 acquires the surroundings information. More specifically, in Step S1, the obstacle information acquisition unit 3 acquires the obstacle information from the obstacle information detection unit 4. In Step S2, the road information acquisition unit 5 acquires the road information from the road information detection unit 6. The action planning apparatus 1 may simultaneously perform Step S1 and Step S2 or may perform Step S1 after performing Step S2.

In Step S3, the scene generation unit 8 generates, using the surroundings information acquired by the surroundings information acquisition unit 2 in Step S1 and Step S2, one or more pieces of scene information indicating the situation in which the host vehicle 20 is placed.

In Step S4, the mode calculation unit 9 determines whether one piece of scene information is generated by the scene generation unit 8 in Step S3.

When determining that one piece of scene information is generated (YES in Step S4), the mode calculation unit 9 calculates one or more modes using the one piece of scene information (Step S5).

When determining that a plurality of pieces of scene information are generated (NO in Step S4), the mode calculation unit 9 calculates a plurality of modes in parallel using the plurality of pieces of scene information (Step S6).

In Step S7, the mode selection unit 10 determines whether one mode is calculated in Step S5 or Step S6.

When the mode selection unit 10 determines that one mode is calculated (YES in Step S7), the mode calculation unit 9 outputs the mode calculated in Step S5 or Step S6 as the action of the host vehicle 20 (Step S8).

When the mode selection unit 10 determines that a plurality of modes are calculated (NO in Step S7), the mode calculation unit 9 selects one of the plurality of modes calculated in Step S5 or Step S6 and outputs the selected one of the modes as the action of the host vehicle 20. (Step S9).

Processing operation performed by the action planning apparatus 1 ends as described above.

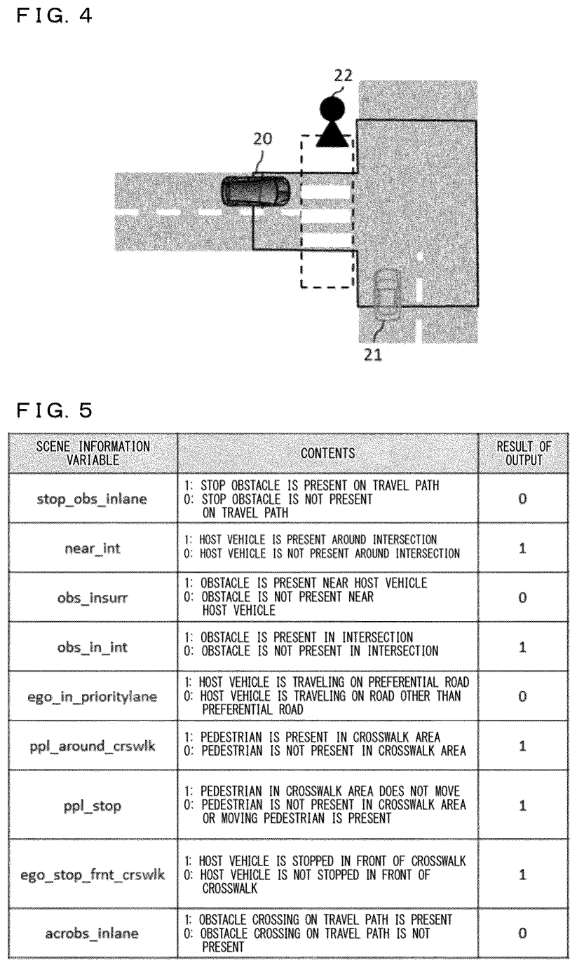

Processing operation performed by the action planning apparatus 1 will specifically be described by taking a situation in which the host vehicle 20 is placed illustrated in FIG. 4 as an example. FIG. 4 is a schematic diagram illustrating the situation in which the host vehicle 20 according to Embodiment 1 is placed. The situation in which the host vehicle 20 is placed illustrated in FIG. 4 is a situation in which the host vehicle 20 waits for the other vehicle 21 to pass to turn right on a non-preferential road at an intersection and is a situation in which the pedestrian 22 is present near a crosswalk. In FIG. 4, a range indicated in a solid line is an intersection area, and a range indicated in a broken line is a crosswalk area.

One example of how the scene generation unit 8 generates one or more pieces of scene information will be described first. The scene generation unit 8 determines, using the road information, whether the host vehicle 20 is present around an intersection, whether the host vehicle 20 is traveling on a preferential road, and whether the host vehicle 20 is traveling around a crosswalk, for example. The scene generation unit 8 also determines, using the obstacle information and the road information, whether the other vehicle 21 is present in the intersection and whether the pedestrian 22 is present near the crosswalk, for example.

Next, the scene generation unit 8 generates a result of determination made using the obstacle information and the road information described above as one or more pieces of scene information as shown in FIG. 5. FIG. 5 is a diagram showing pieces of scene information generated by the scene generation unit 8 according to Embodiment 1. In FIG. 5, a left column indicates a scene information variable, a middle column indicates contents of the scene information variable, and a right column indicates a result of output of a piece of scene information generated by the scene generation unit 8 in a situation shown in FIG. 5. Each piece of scene information may be represented in any form that enables identification of the situation in which the host vehicle 20 is placed, such as a variable including a numerical value and a symbolic representation. In the present embodiment, description will be made on a case where each piece of scene information is represented as a variable including a numerical value. The scene generation unit 8 stores the scene information variable in the left column of FIG. 5 in advance to numerically represent the situation in which the host vehicle 20 is placed as a piece of scene information.

As shown in FIGS. 4 and 5, the scene generation unit 8 generates a piece of scene information stop_obs_inlane=0 because a stop obstacle is not present on a path on which the host vehicle 20 is to turn right, a piece of scene information near_int=1 because the host vehicle 20 is present in the intersection area, a piece of scene information obs_insurr=0 because an obstacle is not present near EVS the host vehicle 20, a piece of scene information obs_in_int=1 because the other vehicle 21 is present in the intersection area, a piece of scene information ego_in_prioritylane=0 because the host vehicle 20 is traveling on a non-preferential road, a piece of scene information ppl_around_crswlk=1 because the pedestrian 22 is present in the crosswalk area, a piece of scene information ppl_stop=1 because the pedestrian 22 is present in the crosswalk area but does not move, a piece of scene information ego_stop_frnt_crswlk=1 because the host vehicle 20 is stopped in front of the crosswalk area, and a piece of scene information acrobs_inlane=0 because an obstacle crossing on the travel path of the host vehicle 20 is not present.

Description will be made on how the scene generation unit 8 determines whether the host vehicle 20 is stopped in front of a crosswalk, which corresponds to a scene information variable ego_stop_frnt_crswlk shown in FIG. 5. The surroundings information acquisition unit 2 acquires surroundings information indicating whether the host vehicle 20 is stopped in front of the crosswalk from an internal sensor installed on the host vehicle 20. The scene generation unit 8 determines whether the host vehicle 20 is stopped in front of the crosswalk using the surroundings information. Alternatively, the surroundings information acquisition unit 2 may acquire the surroundings information using the map acquisition unit 7 of the road information detection unit 6. Specifically, the map acquisition unit 7 outputs, for each calculation period set in advance, information on the position of the host vehicle 20 and information on a stop line of a crosswalk being the road information and takes a difference for each calculation period. The road information detection unit 6 can thus know whether the host vehicle 20 is stopped in front of the crosswalk. How the surroundings information acquisition unit 2 acquires the information on whether the host vehicle 20 is stopped in front of the crosswalk, however, is not limited to this method. Items of pieces of scene information generated by the scene generation unit 8 are not limited to the items shown in FIG. 5. The scene generation unit 8 outputs the one or more pieces of scene information generated as described above to the mode calculation unit 9.

One example of a mode calculation method performed by the mode calculation unit 9 will be described next. As described above, the plurality of mode calculation units 9 calculate one or more modes when one piece of scene information is generated by the scene generation unit 8 and calculate a plurality of modes in parallel when a plurality of pieces of scene information are generated by the scene generation unit 8. An example in which the plurality of mode calculation units 9 are a first mode calculation unit 9a and a second mode calculation unit 9b will be described below. The first mode calculation unit 9a and the second mode calculation unit 9b can perform calculation in parallel. While the example in which the plurality of mode calculation units 9 are the first mode calculation unit 9a and the second mode calculation unit 9b has been shown, it is only necessary to make a design so that at least two modes can be calculated independently of each other.

As one example of the mode calculation method performed by the mode calculation unit 9, a method using a finite state machine (FSM) will be described below.

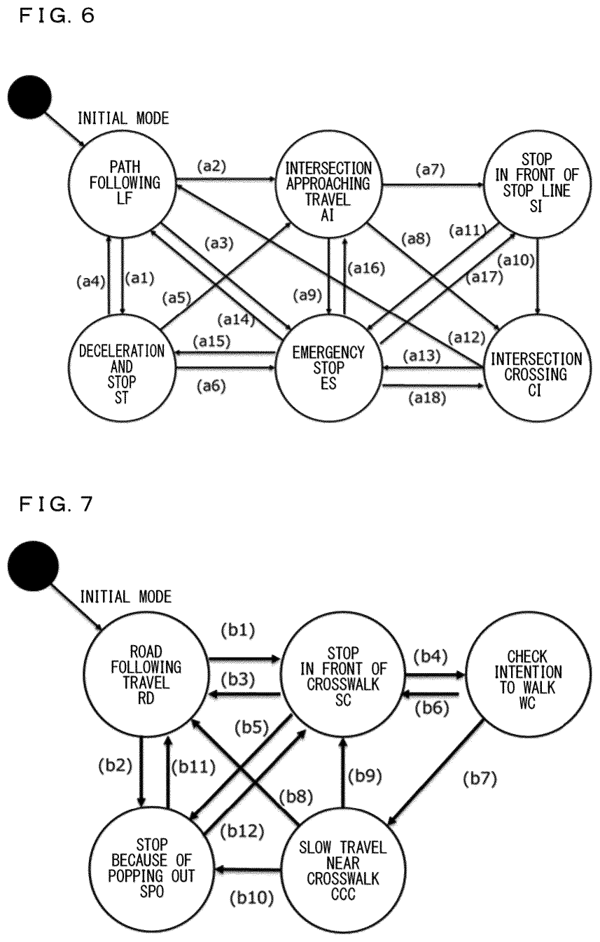

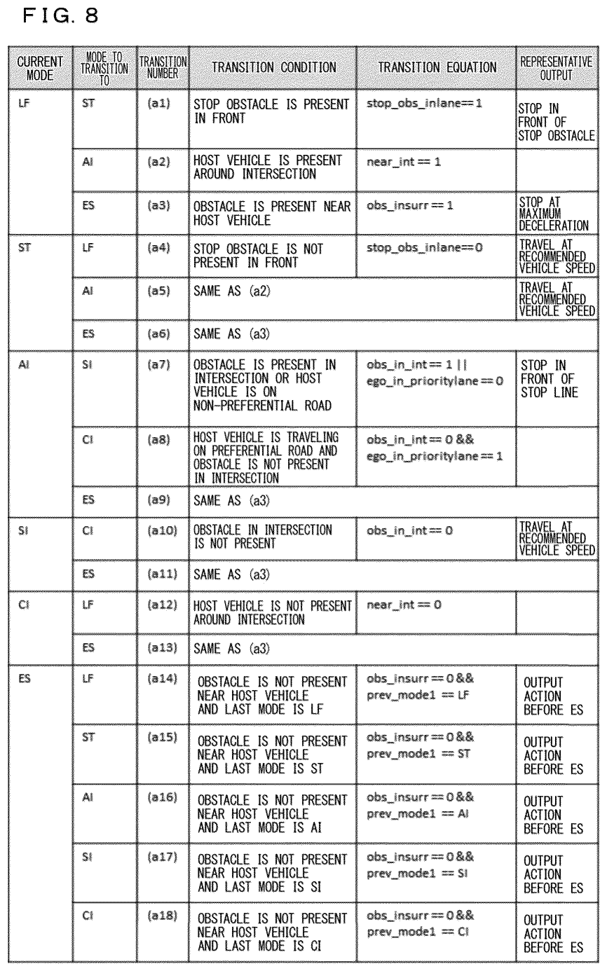

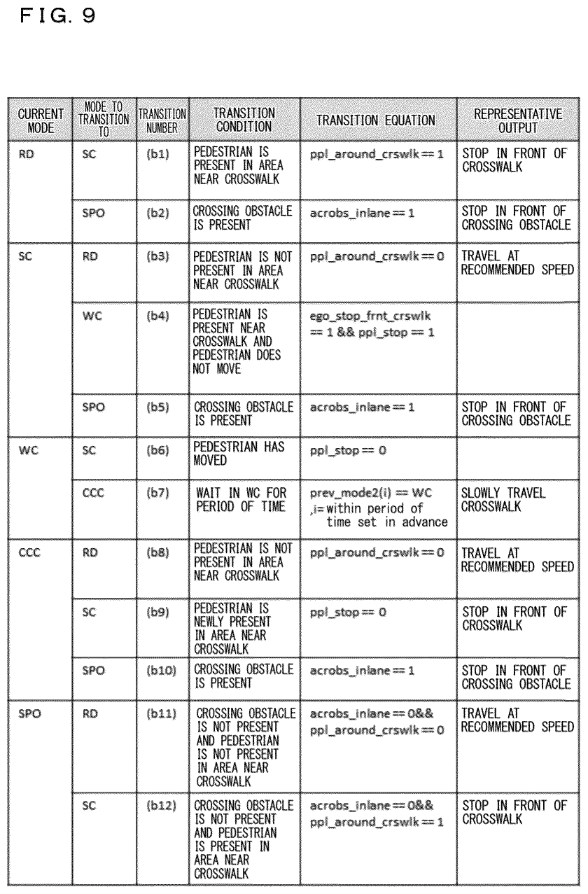

In the present embodiment, description will be made on an example in which the mode calculation unit 9 calculates two modes in parallel using two FSMs when a plurality of pieces of scene information are generated by the scene generation unit 8. Assume that the two FSMs are the first mode calculation unit 9a and the second mode calculation unit 9b below. FIG. 6 is a schematic diagram showing the first mode calculation unit 9a according to Embodiment 1, and FIG. 7 is a schematic diagram showing the second mode calculation unit 9b according to Embodiment 1. FIG. 8 is a diagram showing transition conditions of the first mode calculation unit 9a according to Embodiment 1, and FIG. 9 is a diagram showing transition conditions of the second mode calculation unit 9b according to Embodiment 1.

The first mode calculation unit 9a performs mode calculation to achieve action complying with the road information, and the second mode calculation unit 9b performs mode calculation to achieve action to avoid an obstacle and in line with priority of roads. The FSMs are not limited to those shown in FIGS. 6 and 7 and are only required to determine a finite number of modes and their transition conditions.

As shown in FIG. 6, assume that, as the modes calculated by the first mode calculation unit 9a, six modes are set: path following (hereinafter referred to as “LF (Lane Following)”); deceleration and stop (hereinafter referred to as “ST (STop)”); intersection approaching travel (hereinafter referred to as “AI (Approach Intersection)”); stop in front of a stop line (hereinafter referred to as “SI (Stop Intersection)”); intersection crossing (hereinafter referred to as “CI (Cross Intersection)”); and emergency stop (hereinafter referred to as “ES (Emergency Stop)”).

LF is a mode to travel on the same path. ST is a mode to decelerate and be stopped in front of a stop obstacle. AI is a mode to travel toward a stop line before entering into an intersection. SI is a mode to decelerate and be stopped to be stopped at a stop line in front of an intersection. CI is a mode to cross in an intersection. ES is a mode to be stopped with an emergency when an obstacle is present around a vehicle.

As shown in FIG. 7, assume that, as the modes calculated by the second mode calculation unit 9b, five modes are set: road following travel (hereinafter referred to as “RD (Road Driving)”); stop in front of a crosswalk (hereinafter referred to as “SC (Stop Crosswalk)”); crossing intention check (hereinafter referred to as “WC (Wait Crossing)”); slow travel near a crosswalk (hereinafter referred to as “CCC (Careful Cross Crosswalk)”); and stop because of popping out (hereinafter referred to as “SPO (Stop Popping out Obstacle)”.

RD is a mode to travel on the same path. SC is a mode to decelerate and be stopped when the pedestrian 22 is present near a crosswalk. WC is a mode to check an intention to walk when the pedestrian 22 near the crosswalk does not move. CCC is a mode to slowly travel a crosswalk when the pedestrian 22 near the crosswalk does not move for a period of time. SPO is a mode to be stopped in front of a crossing obstacle when the crossing obstacle appears from a roadside.

The first mode calculation unit 9a and the second mode calculation unit 9b are designed to be able to transition between modes as shown in FIGS. 6 to 9 using the one or more pieces of scene information generated by the scene generation unit 8. The mode calculation unit 9 calculates a mode to transition to using the one or more pieces of scene information generated by the scene generation unit 8 and a current mode of the mode calculation unit 9.

Specifically, when the current mode of the first mode calculation unit 9a is the LF mode, the first mode calculation unit 9a is required to consider only conditional equations corresponding to (a1) to (a3) shown in FIG. 8. Alternatively, the mode calculation unit 9 may calculate the mode to transition to using the one or more pieces of scene information generated by the scene generation unit 8 and a previous mode of the mode calculation unit 9. The previous mode refers to a mode in a calculation period immediately before a calculation period of the current mode or a previous mode in the current calculation period. Assume that the previous mode is herein the mode in the calculation period immediately before the calculation period of the current mode. In this case, determination is made on all the conditional equations shown in FIGS. 8 and 9 to calculate the mode to transition to without depending on the current mode. The previous mode is used as a transition condition. Specifically, an example in which the first mode calculation unit 9a and the second mode calculation unit 9b use previous modes as transition conditions, and the first mode calculation unit 9a uses a previous mode as prev_mode1 in FIG. 8 and the second mode calculation unit 9b uses a previous mode as prev_mode2 in FIG. 9 is shown.

In FIGS. 8 and 9, the current mode represents a mode of the host vehicle 20 at a current time. At the start of autonomous driving, the first mode calculation unit 9a sets the LF mode as an initial mode. That is to say, the first mode calculation unit 9a is assumed to start from the LF mode. The second mode calculation unit 9b sets the RD mode as an initial mode, that is, is assumed to start from the RD mode.

The mode to transition to is a mode to transition to next determined based on the current mode and the transition condition.

A transition number is a number representing transition from the current mode to the mode to transition to, and (a1) to (a18) are provided for the first mode calculation unit 9a, and (b1) to (b12) are provided for the second mode calculation unit 9b. The numbers (a1) to (a18) in FIG. 6 and the numbers (a1) to (a18) in FIG. 8 correspond to each other, and the numbers (b1) to (b12) in FIG. 7 and the numbers (b1) to (b12) in FIG. 9 correspond to each other.

The transition condition is a condition in each transition. A transition equation is a conditional equation representing the transition condition, and there may be a plurality of transition equations. A representative output is an item to which behavior of the host vehicle 20 changes at transition.

Black circles shown in FIGS. 6 and 7 indicate initial modes of the FSMs. The above-mentioned transition of states is calculated from the modes indicated by the black circles as starting points.

For example, when the current mode of the first mode calculation unit 9a is the LF mode, and a transition equation “stop_obs_inlane==1” is satisfied, the first mode calculation unit 9a performs transition of the transition number (a1) and outputs the AI mode as a result of calculation. A representative output in this case is stop in front of the stop obstacle.

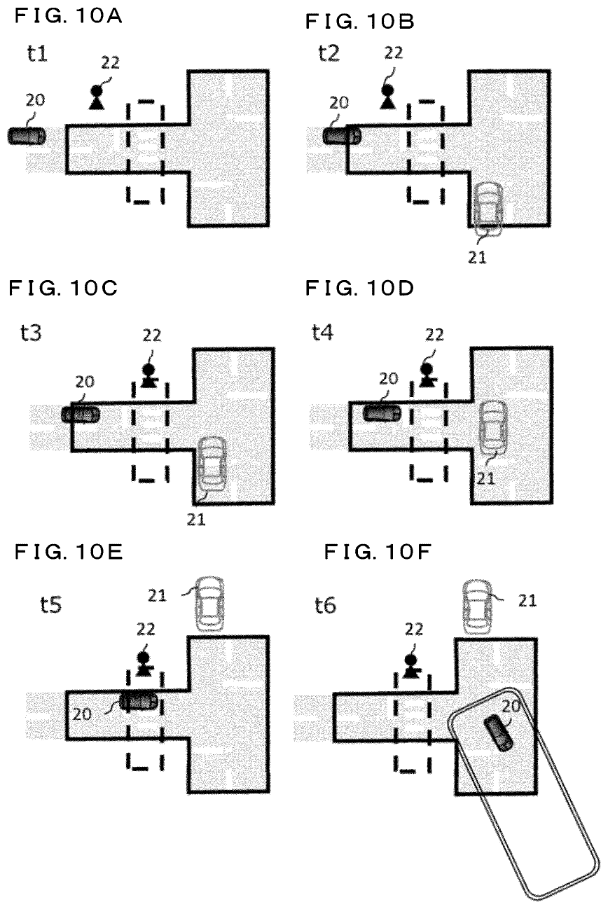

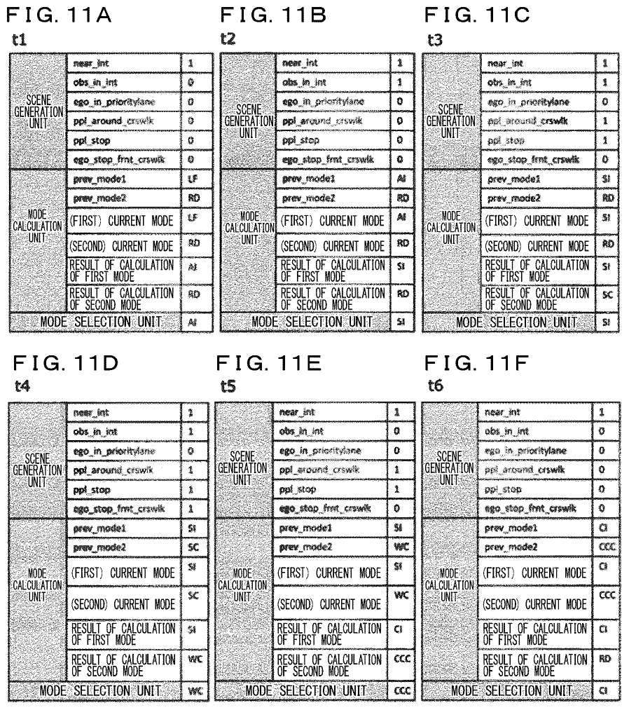

Detailed operation of the action planning apparatus 1 will be described next with reference to FIGS. 10 and 11. FIG. 10 is a schematic diagram illustrating action of the host vehicle 20 including the action planning apparatus 1 according to Embodiment 1. FIG. 10 is a diagram showing action of the host vehicle 20 turning right and passing at an intersection with a crosswalk and with no traffic lights in a time sequence from a time t1 to a time t6. In FIG. 10, ranges indicated in solid lines are intersection areas, and ranges indicated in broken lines are crosswalk areas. FIG. 11 is a diagram showing examples of results of output of the respective components of the action planning apparatus 1 according to Embodiment 1. FIG. 11 is a diagram showing pieces of scene information generated by the scene generation unit 8, a result of calculation of the first mode calculation unit 9a, a result of calculation of the second mode calculation unit 9b, and a result of output of the mode selection unit 10 at each of the time t1 to the time t6 shown in FIG. 10. The times t1 to t6 in FIG. 10 and the times t1 to t6 in FIG. 11 correspond to each other. The previous modes prev_mode1 and prev_mode2 are herein described as the last modes. More specifically, the previous modes are modes in the last calculation periods. Assume that a difference tᵢ₊₁−tᵢ between a time tᵢ₊₁ and a time tᵢ is greater than the calculation period for any value i (i=1 to 5). Only at the time t1, the last modes refer to the initial modes.

In FIG. 10, the time t1 represents a state of the host vehicle 20 approaching an intersection area. As shown in FIG. 11, the last modes of the first mode calculation unit 9a and the second mode calculation unit 9b at the time t1 are respectively the LF mode and the RD mode as the initial modes. The scene generation unit 8 generates the situation in which the host vehicle 20 is placed as pieces of scene information described below using the obstacle information acquired by the obstacle information acquisition unit 3 and the road information acquired by the road information acquisition unit 5. The scene generation unit 8 generates the piece of scene information near_int=1 because the host vehicle 20 is approaching the intersection area, a piece of scene information obs_in_int=0 because the other vehicle 21 is not present in the intersection area, the piece of scene information ego_in_prioritylane=0 because the lane in which the host vehicle 20 is traveling is the non-preferential road, pieces of scene information ppl_around_crswlk=0 and ppl_stop=0 because the pedestrian 22 is not present in the crosswalk area, and a piece of scene information ego_stop_frnt_crswlk=0 because the host vehicle 20 is traveling.

The first mode calculation unit 9a performs transition of the transition number (a2) because a transition equation “near_int==1” is satisfied from the above-mentioned pieces of scene information and the current mode of the first mode calculation unit 9a and outputs the AI mode as a result of calculation.

The second mode calculation unit 9b remains in the same RD mode because transition conditions of the transition numbers (b1) and (b2) are not satisfied from the above-mentioned pieces of scene information and the current mode of the second mode calculation unit 9b. That is to say, the second mode calculation unit 9b outputs the RD mode as a result of calculation.

When calculating the modes, the first mode calculation unit 9a and the second mode calculation unit 9b herein perform calculation independently of each other. The mode calculation unit 9 can thus perform calculation of the first mode calculation unit 9a and calculation of the second mode calculation unit 9b in parallel.

The mode selection unit 10 selects one of the modes calculated by the first mode calculation unit 9a and the second mode calculation unit 9b and outputs the selected one of the modes as the action of the host vehicle 20. In this case, when the mode calculated by the first mode calculation unit 9a and the mode calculated by the second mode calculation unit 9b are different, the mode selection unit 10 preferentially selects a mode to address a risk that can occur due to an obstacle. That is to say, the mode selection unit 10 selects the AI mode (intersection approaching travel) calculated by the first mode calculation unit 9a at the time t1 because the AI mode is the mode to address the risk that can occur due to the obstacle compared with the RD mode (road following travel) calculated by the second mode calculation unit 9b.

In FIG. 10, the time t2 represents a situation in which the host vehicle 20 is approaching a stop line at an intersection and represents a state of the other vehicle 21 entering the intersection area and the pedestrian 22 approaching the crosswalk area. As shown in FIG. 11, the last modes of the first mode calculation unit 9a and the second mode calculation unit 9b at the time t2 are respectively the AI mode and the RD mode. The mode calculation unit 9 holds the modes calculated by the first mode calculation unit 9a and the second mode calculation unit 9b at the time t1 as the last modes at the time t2 because the modes do not change between the time t1 and the time t2. The same applies to the last modes at the other times. The current modes of the first mode calculation unit 9a and the second mode calculation unit 9b at the time t2 are respectively the AI mode and the RD mode.

The scene generation unit 8 generates the situation in which the host vehicle 20 is placed as pieces of scene information described below using the obstacle information acquired by the obstacle information acquisition unit 3 and the road information acquired by the road information acquisition unit 5. The scene generation unit 8 generates the piece of scene information near_int=1 because the host vehicle 20 is present in the intersection area, the piece of scene information obs_in_int=1 because the other vehicle 21 is present in the intersection area, the piece of scene information ego_in_prioritylane=0 because the lane in which the host vehicle 20 is traveling is the non-preferential road, the pieces of scene information ppl_around_crswlk=0 and ppl_stop=0 because the pedestrian 22 is not present in the crosswalk area, and the piece of scene information ego_stop_frnt_crswlk=0 because the host vehicle 20 is traveling.

The first mode calculation unit 9a performs transition of the transition number (a7) because a transition equation “obs_in_int==1|ego_in_prioritylane==0” is satisfied from the above-mentioned pieces of scene information and the current mode of the first mode calculation unit 9a and outputs the SI mode as a result of calculation.

The second mode calculation unit 9b remains in the same RD mode because the transition conditions of the transition numbers (b1) and (b2) are not satisfied from the above-mentioned pieces of scene information and the current mode of the second mode calculation unit 9b. That is to say, the second mode calculation unit 9b outputs the RD mode as a result of calculation.

The mode selection unit 10 selects the SI mode (stop in front of the stop line) calculated by the first mode calculation unit 9a and outputs the selected SI mode as the action of the host vehicle 20 because the SI mode is the mode to address the risk that can occur due to the obstacle compared with the RD mode (road following travel) calculated by the second mode calculation unit 9b.

In FIG. 10, the time t3 represents a state of the other vehicle 21 passing through the intersection when the host vehicle 20 is approaching the stop line at the intersection and the pedestrian 22 stopping in the crosswalk area. As shown in FIG. 11, the last modes of the first mode calculation unit 9a and the second mode calculation unit 9b at the time t3 are respectively the SI mode and the RD mode. The current modes of the first mode calculation unit 9a and the second mode calculation unit 9b at the time t3 are respectively the SI mode and the RD mode. The scene generation unit 8 generates the pieces of scene information near_int=1, obs_in_int=1, and ego_in_prioritylane=0 because near_int, obs_in_int, and ego_in_prioritylane are similar to those in the scene at the time t2, a piece of scene information ppl_around_crswlk=1 because the pedestrian 22 is present in the crosswalk area, a piece of scene information ppl_stop=1 because the pedestrian 22 in the crosswalk area stops, and the piece of scene information ego_stop_frnt_crswlk=0 because the host vehicle 20 is traveling.

The first mode calculation unit 9a remains in the same SI mode because transition conditions of the transition numbers (a10) and (a11) are not satisfied from the above-mentioned pieces of scene information and the current mode of the first mode calculation unit 9a. That is to say, the first mode calculation unit 9a outputs the SI mode as a result of calculation.

The second mode calculation unit 9b performs transition of the transition number (b1) because the transition equation “ppl_around_crswlk==1” is satisfied from the above-mentioned pieces of scene information and the current mode of the second mode calculation unit 9b and outputs the SC mode as a result of calculation. As for the time t3, the SI mode (stop in front of the stop line) as a result of calculation of the first mode calculation unit 9a and the SC mode (stop in front of the crosswalk) as a result of calculation of the second mode calculation unit 9b are both scenes with risks that can occur due to obstacles. In this case, the mode selection unit 10 can weight degrees of risk in advance and herein selects the SI mode and outputs the selected SI mode as the action of the host vehicle 20.

In FIG. 10, the time t=t4 represents a state of the other vehicle 21 passing through the intersection when the host vehicle 20 is stopped in front of the stop line at the intersection and the pedestrian 22 stopping in the crosswalk area. As shown in FIG. 11, the last modes of the first mode calculation unit 9a and the second mode calculation unit 9b at the time t4 are respectively the SI mode and the SC mode. The current modes of the first mode calculation unit 9a and the second mode calculation unit 9b at the time t4 are respectively the SI mode and the SC mode. The scene generation unit 8 generates the pieces of scene information near_int=1, obs_in_int=1, and ego_in_prioritylane=0 because near_int, obs_in_int, and ego_in_prioritylane are similar to those in the scene at the time t3, the pieces of scene information ppl_around_crswlk=1 and ppl_stop=1 because ppl_around_crswlk and ppl_stop are also similar to those in the scene at the time t3, and the piece of scene information ego_stop_frnt_crswlk=1 because the host vehicle 20 is stopped in front of the crosswalk.

The first mode calculation unit 9a remains in the same SI mode because the transition conditions of the transition numbers (a10) and (a11) are not satisfied from the above-mentioned pieces of scene information and the current mode of the first mode calculation unit 9a. That is to say, the first mode calculation unit 9a outputs the SI mode as a result of calculation.

The second mode calculation unit 9b performs transition of the transition number (b4) because a transition equation “ego_stop_frnt_crswlk==1&&ppl_stop==1” is satisfied from the above-mentioned pieces of scene information and the current mode of the second mode calculation unit 9b and outputs the WC mode as a result of calculation.

The mode selection unit 10 selects the WC mode (crossing intention check) calculated by the second mode calculation unit 9b and outputs the selected WC mode as the action of the host vehicle 20 because the WC mode is the mode to address the risk that can occur due to the obstacle compared with the SI mode (stop in front of the stop line) calculated by the first mode calculation unit 9a.

In FIG. 10, the time t5 represents a state of the host vehicle 20 slowly traveling in the crosswalk area to pass through the crosswalk area because the pedestrian 22 still stops in the crosswalk area although the other vehicle 21 has passed through the intersection when the host vehicle 20 is stopped in front of the stop line from the time t4 to the time t5. As shown in FIG. 11, the last modes of the first mode calculation unit 9a and the second mode calculation unit 9b at the time t5 are respectively the SI mode and the WC mode. The current modes of the first mode calculation unit 9a and the second mode calculation unit 9b at the time t5 are respectively the SI mode and the WC mode. The scene generation unit 8 generates the pieces of scene information near_int=1 and ego_in_prioritylane=0 because near_int and ego_in_prioritylane are similar to those in the scene at the time t4, the piece of scene information obs_in_int=0 because the other vehicle 21 is no longer present in the intersection area, the pieces of scene information ppl_around_crswlk=1 and ppl_stop=1 because ppl_around_crswlk and ppl_stop are similar to those in the scene at the time t4, and the piece of scene information ego_stop_frnt_crswlk=0 because the host vehicle 20 starts traveling.

The first mode calculation unit 9a performs transition of the transition number (a10) because the transition equation “obs_in_int==0” is satisfied from the above-mentioned pieces of scene information and the current mode of the first mode calculation unit 9a and outputs the CI mode as a result of calculation.

The second mode calculation unit 9b performs transition of the transition number (b7) because a transition equation “prev_mode2(i)==WC, i==within a period of time set in advance” is satisfied from the above-mentioned pieces of scene information and the current mode of the second mode calculation unit 9b and outputs the CCC mode as a result of calculation. A specific example of the transition equation is shown below. Assume that the time t5 and the time t4 has a difference Δt×4. Δt is a calculation period. That is to say, assume that calculation periods t=t4+Δt, t=t4+Δt×2, and t=t4+Δt×3 are included between the time t4 and the time t5. prev_mode2 at the time t=t4+Δt, that is, prev_mode2 (t4+Δt) is the SC mode, which is the same as the current mode at the time t4. On the other hand, prev_mode2 (t4+Δt×2)=WC, prev_mode2 (t4+Δt×3)=WC, and prev_mode2 (t5)=WC are satisfied, and prev_mode2 is the WC mode for the period of time set in advance. Thus, at the time t5, the above-mentioned transition equation is satisfied, so that a result of calculation of the second mode calculation unit 9b is CCC according to the transition number (b7) in FIG. 9. Assume that a period of time WC for which prev_mode2 is continued is set in advance.

The mode selection unit 10 selects the CCC mode (slow travel near the crosswalk) calculated by the second mode calculation unit 9b and outputs the selected CCC mode as the action of the host vehicle 20 because the CCC mode is the mode to address the risk that can occur due to the obstacle compared with the CI mode (intersection crossing) calculated by the first mode calculation unit 9a.

In FIG. 10, the time t6 represents a state of the host vehicle 20 turning right in the intersection. As shown in FIG. 11, the last modes of the first mode calculation unit 9a and the second mode calculation unit 9b at the time t6 are respectively the CI mode and the CCC mode. The current modes of the first mode calculation unit 9a and the second mode calculation unit 9b at the time t6 are respectively the CI mode and the CCC mode. The scene generation unit 8 generates the pieces of scene information near_int=1, obs_in_int=0, and ego_in_prioritylane=0 because near_int, obs_in_int, and ego_in_prioritylane are similar to those in the scene at the time t4. The scene generation unit 8 may set a scene calculation area around the host vehicle 20 in advance when generating the pieces of scene information. In FIG. 10, the scene calculation area is indicated by a double solid line. In this case, the scene generation unit 8 generates the pieces of scene information ppl_around_crswlk=0) and ppl_stop=0 because the crosswalk area falls outside the scene calculation area and the piece of scene information ego_stop_frnt_crswlk=0 because the host vehicle 20 is traveling.

The first mode calculation unit 9a remains in the same CI mode because transition conditions of the transition numbers (a12) and (a13) are not satisfied from the above-mentioned pieces of scene information and the current mode of the first mode calculation unit 9a. That is to say, the first mode calculation unit 9a outputs the CI mode as a result of calculation.

The second mode calculation unit 9b performs transition of the transition number (b8) because a transition equation “ppl_around_crswlk==0” is satisfied from the above-mentioned pieces of scene information and the current mode of the second mode calculation unit 9b and outputs the RD mode as a result of calculation.

The mode selection unit 10 selects the CI mode (intersection crossing) calculated by the first mode calculation unit 9a and outputs the selected CI mode as the action of the host vehicle 20 because the CI mode is the mode to address the risk that can occur due to the obstacle compared with the RD mode (road following travel) calculated by the second mode calculation unit 9b.

When one piece of scene information is generated by the scene generation unit 8, one or more modes are calculated as candidates for action that the host vehicle can take using the one piece of scene information. That is to say, the mode calculation unit 9 calculates one mode using one of the first mode calculation unit 9a and the second mode calculation unit 9b, and the mode selection unit 10 outputs the mode calculated by the mode calculation unit 9 as the action of the host vehicle 20. Alternatively, the mode calculation unit 9 may calculate respective modes using both the first mode calculation unit 9a and the second mode calculation unit 9b, and the mode selection unit 10 may select one of the modes calculated by the first mode calculation unit 9a and the second mode calculation unit 9b and output the selected one of the modes as the action of the host vehicle 20.

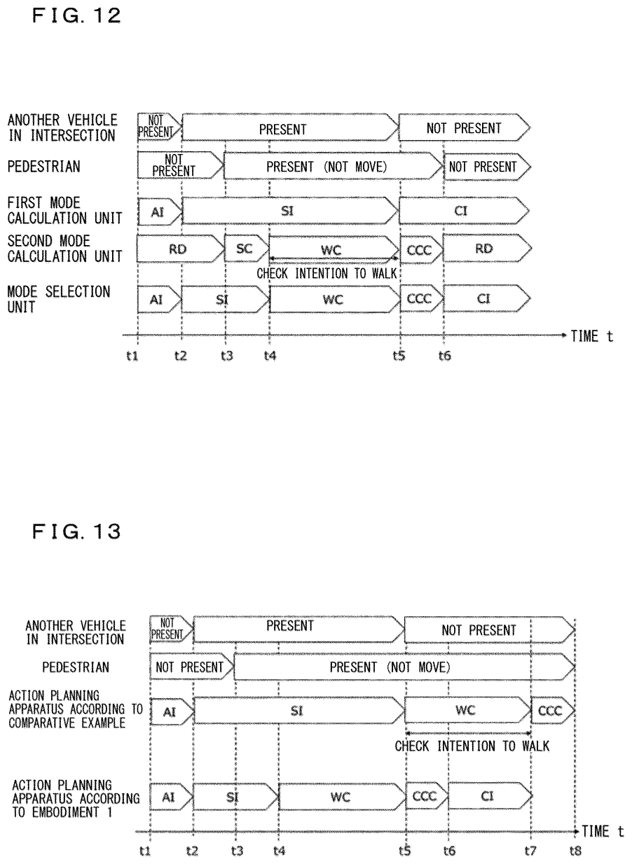

Effects of the action planning apparatus 1 according to the present embodiment will be described next with reference to FIGS. 12 and 13. FIG. 12 is a diagram showing operation of the action planning apparatus 1 according to Embodiment 1 in a time sequence. FIG. 13 is a diagram showing operation of an action planning apparatus according to a comparative example of Embodiment 1 in a time sequence. FIG. 12 shows a flow of processing operation performed by the action planning apparatus 1 shown in FIGS. 10 and 11 in a time sequence. The times t1 to t6 in FIGS. 12 and 13 match the times t1 to t6 shown in FIGS. 10 and 11.

The action planning apparatus according to Embodiment 1 includes the plurality of mode calculation units 9, and the plurality of mode calculation units 9 calculate the plurality of modes in parallel when the plurality of pieces of scene information are generated. In the present embodiment, the example in which the mode calculation unit 9 includes the first mode calculation unit 9a and the second mode calculation unit 9b, and the first mode calculation unit 9a and the second mode calculation unit 9b calculate the two modes in parallel when the plurality of pieces of scene information are generated has been shown.

As shown in FIG. 12, the action planning apparatus 1 according to Embodiment 1 outputs the mode to check the intention to walk of the pedestrian 22 using the second mode calculation unit 9b from the time t4 to the time t5. This enables the host vehicle 20 to slowly travel and pass at the time t5 after the other vehicle 21 exits the intersection. The action planning apparatus 1 according to Embodiment 1 can thus avoid conservative action compared with the action planning apparatus according to the comparative example, which will be described below.

In contrast, the action planning apparatus according to the comparative example shown in FIG. 13 includes a single mode calculation unit. That is to say, the mode calculation unit of the action planning apparatus according to the comparative example cannot calculate the plurality of modes in parallel when the plurality of pieces of scene information are generated. The single mode calculation unit of the action planning apparatus according to the comparative example outputs one mode considered to be the safest using the one or more pieces of scene information. FIG. 13 shows processing operation performed by the action planning apparatus according to the comparative example in a time sequence as for an operational scenario of the pedestrian 22 and the other vehicle 21 illustrated in FIG. 10.

In FIG. 13, a result of output of the mode selection unit 10 of the action planning apparatus 1 according to Embodiment 1 shown in FIG. 12 is shown to be superimposed for comparison between operation of the action planning apparatus 1 according to Embodiment 1 and operation of the action planning apparatus according to the comparative example.

When being stopped in front of the stop line at the time t4, the host vehicle 20 is required to take action to wait for the other vehicle 21 to pass through the intersection, wait for the pedestrian 22 to pass, and check the intention to walk of the pedestrian 22. For these situations, the single mode calculation unit of the action planning apparatus according to the comparative example outputs not the WC mode to check the intention to walk but the SI mode to be stopped in front of the stop line considered to be the safest as shown in FIG. 13. The action planning apparatus according to the comparative example thus starts checking the intention to walk at the time t5 when the other vehicle 21 in the intersection ends passing through the intersection. That is to say, the action planning apparatus according to the comparative example causes the host vehicle 20 to be stopped at the intersection for a longer time and to take more conservative action than the action planning apparatus 1 according to Embodiment 1.

As described above, operation of the action planning apparatus 1 according to the present embodiment that can calculate the modes in parallel using the plurality of mode calculation units 9 and operation of the action planning apparatus according to Comparative Example 1 that includes the single mode calculation unit 9 respectively include slow travel from the time t5 and slow travel from the time t7 and differ in stop time when a time to check the intention to walk is similarly secured.

That is to say, the action planning apparatus 1 according to the present embodiment calculates, when the plurality of pieces of scene information are generated by the scene generation unit 8, the plurality of modes in parallel using the plurality of pieces of scene information and selects one of the modes calculated in the calculating step and outputs the selected one of the modes as the action of the host vehicle 20. Conservative action can thereby be avoided in a composite scene compared with the action planning apparatus according to the comparative example.

When calculating the modes, the plurality of mode calculation units 9 perform calculation independently of one another. That is to say, the mode calculated by the first mode calculation unit 9a is not affected by the mode calculated by the second mode calculation unit 9b. The same applies to the opposite. Specifically, the plurality of mode calculation units 9 calculate the modes using the one or more pieces of scene information and the respective current modes of the plurality of mode calculation units 9. Alternatively, the plurality of mode calculation units 9 calculate the modes using the one or more pieces of scene information and the respective previous modes of the plurality of mode calculation units 9. The plurality of mode calculation units 9 can thus calculate the plurality of modes in parallel. Compared with the above-mentioned action planning apparatus according to the comparative example including the single mode calculation unit 9, action of the host vehicle can more quickly be planned, and the stop time at the intersection can be reduced, so that conservative action can be avoided.

The action planning apparatus 1 according to the present embodiment generates the one or more pieces of scene information using the surroundings information being information on obstacles and roads present around the host vehicle and calculates the plurality of modes in parallel to plan action of the host vehicle 20 at each time. The host vehicle 20 can thus take action that is safe and does not interfere with traffic, and applicability of autonomous driving can be expanded.

While the method using the FSM has been described as the method performed by the mode calculation unit 9, the method performed by the mode calculation unit 9 is not limited to the method using the FSM. Various methods can be used as the method performed by the mode calculation unit 9, including a method using a neural network and the like for pre-learning and a method using a preliminary rule represented by ontology and the like to determine action of the host vehicle 20. That is to say, the mode calculation unit 9 is only required to be at least one of the FSM, the neural network, and the ontology.

While the example in which the first mode calculation unit 9a and the second mode calculation unit 9b simultaneously calculate the modes when the plurality of pieces of scene information are generated by the scene generation unit 8 has been shown, calculation of the modes is not limited to calculation in this manner. The plurality of mode calculation units 9 may sequentially perform calculation within one calculation period. That is to say, calculation of the plurality of modes in parallel performed by the plurality of mode calculation units 9 includes calculation of the plurality of modes within one calculation period performed by the plurality of mode calculation units 9.

### Embodiment 2

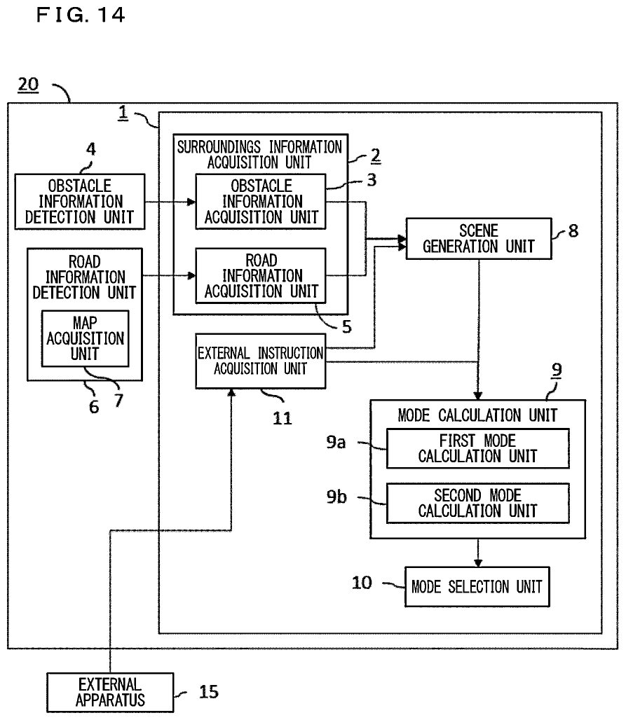

An action planning apparatus 1 according to Embodiment 2 will be described with reference to FIG. 14. FIG. 14 is a block diagram showing a portion of a host vehicle 20 including the action planning apparatus 1 according to Embodiment 2. The action planning apparatus 1 according to Embodiment 2 differs from the action planning apparatus 1 according to Embodiment 1 in that an external instruction acquisition unit 11 is included. Description duplicative of description in Embodiment 1 will be omitted. The action planning apparatus 1 according to Embodiment 2 plans action of the host vehicle 20 using the surroundings information acquired by the surroundings information acquisition unit 2 and external instruction information acquired by the external instruction acquisition unit 11.

The external instruction acquisition unit 11 is provided separately from the obstacle information detection unit 4 and the road information detection unit 6, acquires information from an external apparatus 15 provided external to the action planning apparatus 1, and outputs the acquired information to the scene generation unit 8 and the mode calculation unit 9. The external apparatus 15 is at least one of a controller, a mobile terminal, such as a smartphone, and an operator provided to the host vehicle 20, for example. The information acquired by the external instruction acquisition unit 11 is referred to as the external instruction information. The external instruction information is information indicating an instruction on driving of the host vehicle 20 from the external apparatus 15 and is, specifically, an instruction to be stopped at a stop, an instruction to be stopped on the spot, an instruction to resume on the spot, an instruction to enter a parking space, an instruction to exit the parking space, an instruction to allow passing at an intersection, an instruction to prohibit passing, or the like.

The scene generation unit 8 generates the situation in which the host vehicle 20 is placed as the one or more pieces of scene information using the surroundings information acquired by the surroundings information acquisition unit 2 and the external instruction information acquired by the external instruction acquisition unit 11.

The mode calculation unit 9 calculates, using the one or more pieces of scene information generated by the scene generation unit 8 and the external instruction information acquired by the external instruction acquisition unit 11, one or more modes as candidates for action that the host vehicle 20 can take. As in Embodiment 1, the mode calculation unit 9 calculates one or more modes when one piece of scene information is generated by the scene generation unit 8 and calculates a plurality of modes in parallel when a plurality of pieces of scene information are generated by the scene generation unit 8. When the plurality of modes are calculated, the mode selection unit 10 selects one of the modes calculated in the calculating step and outputs the selected one of the modes as action of the host vehicle 20.

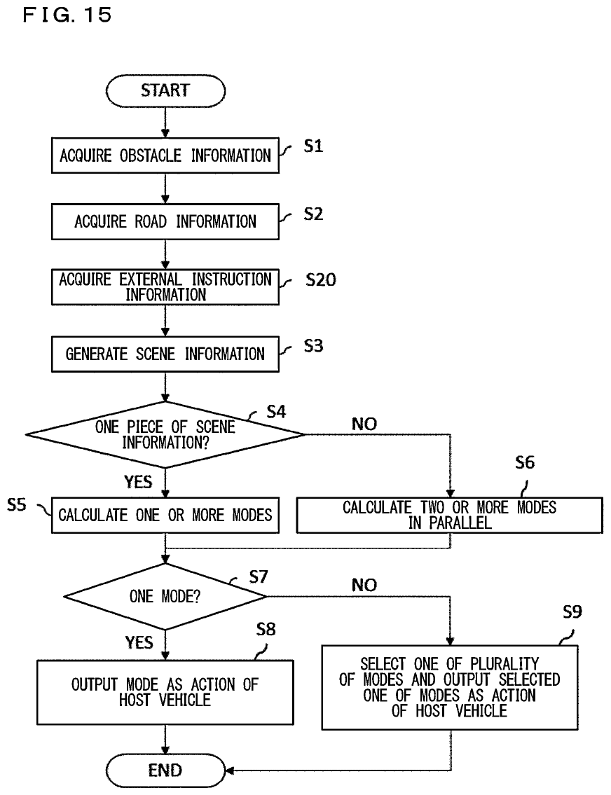

An action planning method performed by the action planning apparatus 1 will be described next. FIG. 15 is a flowchart showing the action planning method according to Embodiment 2. Processing operation in the flowchart of FIG. 15 is repeatedly performed during travel of the host vehicle 20. In the present embodiment, description will be made based on an assumption that a period from START to END shown in FIG. 15 is one calculation period.

Step S1 and Step S2 are similar to those of the action planning method according to Embodiment 1.

In Step S20, the external instruction acquisition unit 11 acquires the external instruction information from the external apparatus 15.

In Step S3, the scene generation unit 8 generates, using the surroundings information and the external instruction information acquired in Step S1 to Step S3, the situation in which the host vehicle 20 is placed as the one or more pieces of scene information.

In Step S4, the mode calculation unit 9 determines whether one piece of scene information is generated by the scene generation unit 8 in Step S3.

When determining that one piece of scene information is generated (YES in Step S4), the mode calculation unit 9 calculates one or more modes using the surroundings information and the external instruction information acquired in Step S1 to Step S3 (Step S5).

When determining that a plurality of pieces of scene information are generated (NO in Step S4), the mode calculation unit 9 calculates a plurality of modes in parallel using the surroundings information and the external instruction information acquired in Step S1 to Step S3 (Step S6).

Step S7 to Step S9 are similar to those of the action planning method according to Embodiment 1.

Processing operation performed by the action planning apparatus 1 ends as described above.

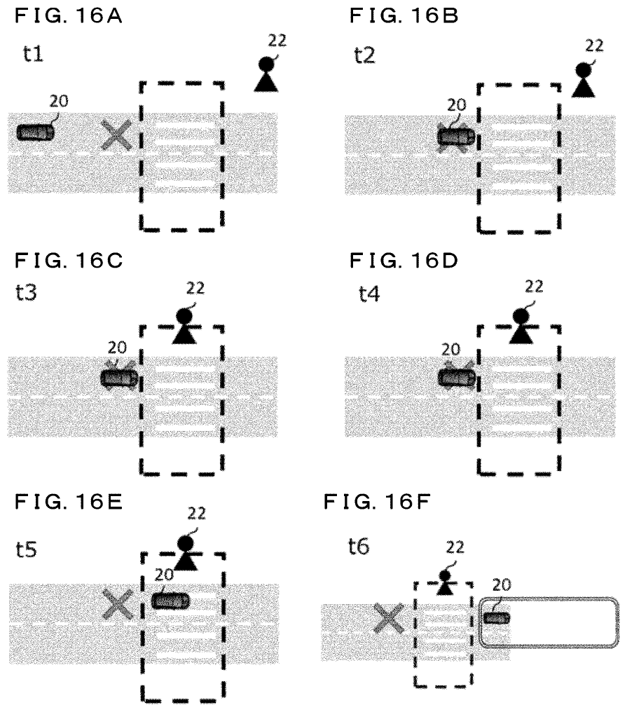

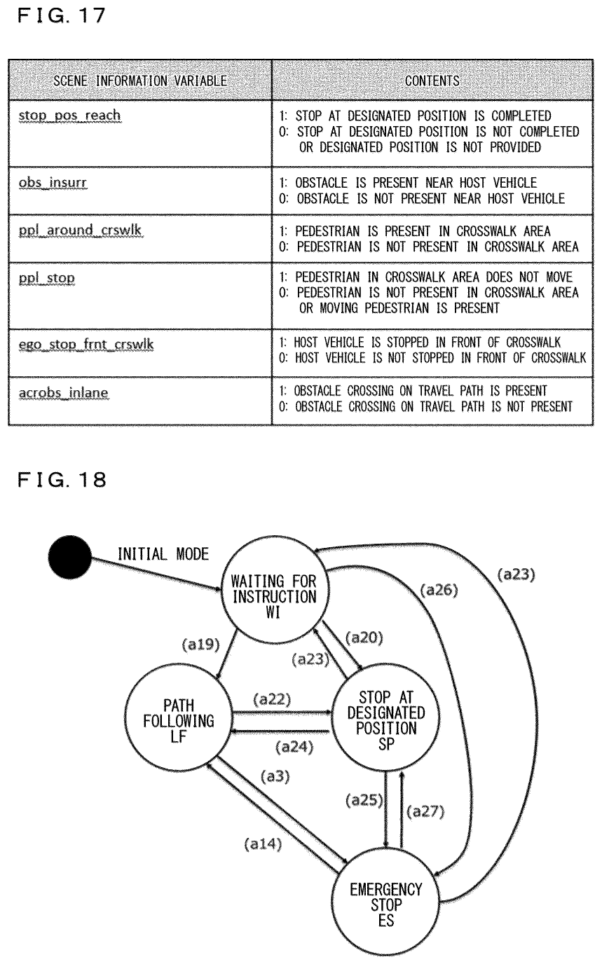

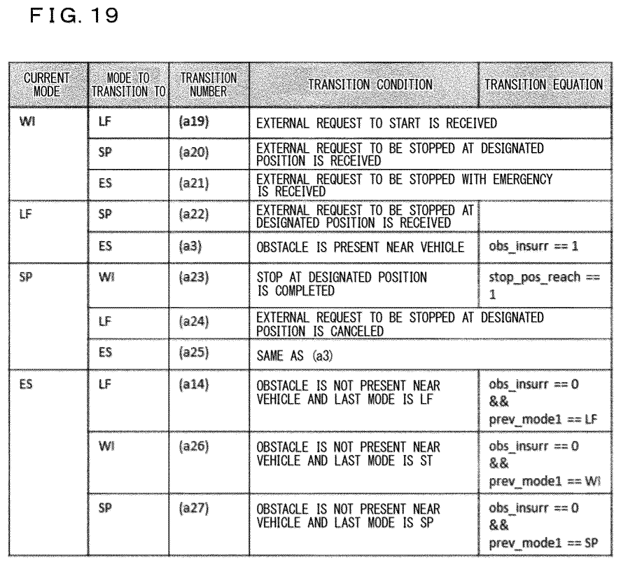

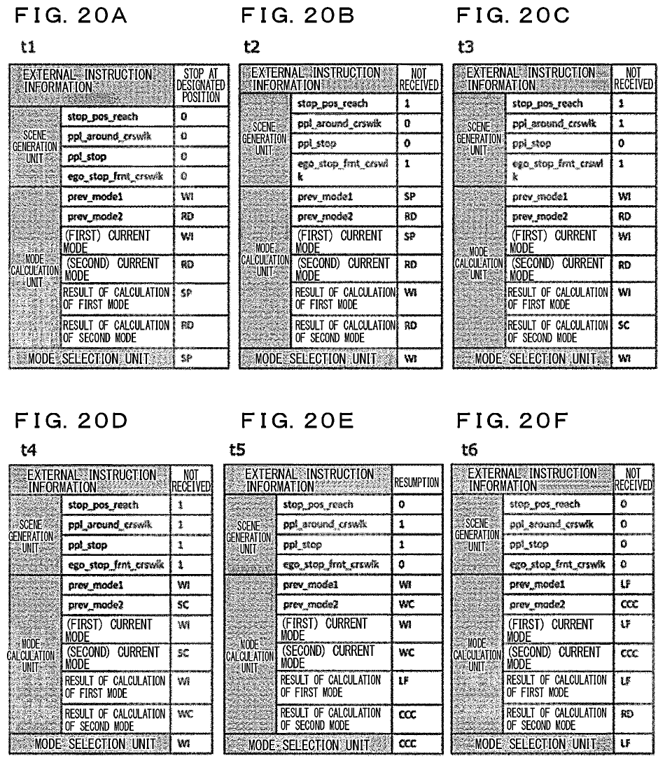

Detailed operation of the action planning apparatus 1 will be described next with reference to FIGS. 16 to 20. FIG. 16 is a schematic diagram illustrating action of the host vehicle 20 including the action planning apparatus 1 according to Embodiment 2. FIG. 16 is a diagram showing action of the host vehicle 20 receiving an instruction to be stopped at a designated position around a crosswalk from a controller, then receiving an instruction to resume driving from the designated position from the controller again, and passing through the crosswalk while taking the pedestrian 22 around the crosswalk into consideration in a time sequence from a time t1 to a time t6. In FIG. 16, the designated position is indicated by a cross mark, and the crosswalk area has a range indicated in a broken line. FIG. 17 is a diagram showing pieces of scene information generated by the scene generation unit 8 according to Embodiment 2. As shown in FIG. 17, the scene generation unit 8 defines the generated pieces of scene information in advance. FIG. 18 is a schematic diagram showing a first mode calculation unit 9a according to Embodiment 2. FIG. 19 is a diagram showing transition conditions of the first mode calculation unit 9a according to Embodiment 2. FIG. 20 is a diagram showing examples of results of output of the respective components of the action planning apparatus 1 according to Embodiment 2.

The mode calculation unit 9 includes the first mode calculation unit 9a shown in FIG. 18 and the second mode calculation unit 9b shown in FIG. 7. The first mode calculation unit 9a and the second mode calculation unit 9b are designed to be able to perform calculation independently of each other as in Embodiment 1.

The first mode calculation unit 9a performs mode calculation not only to achieve action complying with the road information but also to achieve action complying with the external instruction information.

FIG. 18 shows an example in which, as the modes calculated by the first mode calculation unit 9a, four modes are set: waiting for an instruction (hereinafter referred to as “WI (Wait Instruction)”; LF; stop at the designated position (hereinafter referred to as “SP (Stop Position)”; and ES. LF and ES are the same as the modes described on the first mode calculation unit 9a according to Embodiment 1. WI is a mode to wait for an external instruction when autonomous driving is started or resumed. SP is a mode to decelerate and be stopped to be stopped at the designated position when an external instruction to be stopped at the designated position is received.

The second mode calculation unit 9b performs mode calculation to achieve action to avoid an obstacle and in line with priority of roads. The second mode calculation unit 9b is similar to that according to Embodiment 1.

FIG. 19 is a diagram showing the transition conditions of the first mode calculation unit 9a shown in FIG. 18. The first mode calculation unit 9a is designed to be able to transition between modes using the one or more pieces of scene information generated by the scene generation unit 8 and the external instruction information. In FIG. 19, the current mode represents the current mode of the host vehicle 20, and the first mode calculation unit 9a sets WI as an initial mode, that is, is assumed to start from WI at the start of autonomous driving and the like. The mode to transition to is a mode to transition to next based on the current mode and the transition condition. The transition number is a number representing transition from the current mode to the mode to transition to, and (a3) to (a27) are provided for the first mode calculation unit 9a. The numbers in FIG. 18 and the numbers in FIG. 19 correspond to each other. A black circle shown in FIG. 18 indicates an initial mode of the FSM. The above-mentioned transition of a state is calculated from the mode indicated by the black circle as a starting point.

FIG. 20 is a diagram showing the external instruction information, pieces of scene information generated by the scene generation unit 8, results of calculation of the last mode and the current mode of the first mode calculation unit 9a, results of calculation of the last mode and the current mode of the second mode calculation unit 9b, and a result of output of the mode selection unit 10 at each of the time t1 to the time t6 shown in FIG. 16. The times t1 to t6 in FIG. 16 and the times t1 to t6 in FIG. 20 correspond to each other.

In FIG. 16, the time t1 represents a state of the host vehicle 20 having waited for an external instruction receiving an instruction to be stopped at the designated position from the external apparatus 15 and traveling. The external instruction acquisition unit 11 acquires the external instruction information indicating the instruction to be stopped at the designated position from the controller. As shown in FIG. 20, the last modes of the first mode calculation unit 9a and the second mode calculation unit 9b at the time t1 are respectively the WI mode and the RD mode as the initial modes. The current modes of the first mode calculation unit 9a and the second mode calculation unit 9b at the time t1 are respectively the WI mode and the RD mode as the initial modes. The scene generation unit 8 generates the situation in which the host vehicle 20 is placed as pieces of scene information described below using the surroundings information acquired by the surroundings information acquisition unit 2 and the external instruction information acquired by the external instruction acquisition unit 11. That is to say, the scene generation unit 8 generates a piece of scene information stop_pos_reach=0 because the host vehicle 20 is traveling toward the designated position from the external apparatus 15 but does not reach the designated position, the pieces of scene information ppl_around_crswlk=0 and ppl_stop=0 because the pedestrian 22 is not present in the crosswalk area, and the piece of scene information ego_stop_frnt_crswlk=0 because the host vehicle 20 is stopped but is away from the crosswalk area.

The first mode calculation unit 9a performs transition of the transition number (a20) because the transition condition of the transition number (a20) is satisfied from the external instruction information, the above-mentioned pieces of scene information, and the current mode of the first mode calculation unit 9a and outputs the SP mode as a result of calculation.

The second mode calculation unit 9b remains in the same RD mode because the transition conditions of the transition numbers (b1) and (b2) are not satisfied from the above-mentioned pieces of scene information and the current mode of the second mode calculation unit 9b. That is to say, the second mode calculation unit 9b outputs the RD mode as a result of calculation.

The mode selection unit 10 selects the SP mode (stop at the designated position) calculated by the first mode calculation unit 9a and outputs the selected SP mode as the action of the host vehicle 20 because the SP mode is the mode to address the risk that can occur due to the obstacle compared with the RD mode (road following travel) calculated by the second mode calculation unit 9b.

In FIG. 16, the time t2 represents a state of the host vehicle 20 completing being stopped at the designated position. As shown in FIG. 20, the last modes of the first mode calculation unit 9a and the second mode calculation unit 9b at the time t2 are respectively the SP mode and the RD mode. The current modes of the first mode calculation unit 9a and the second mode calculation unit 9b at the time t2 are respectively the SP mode and the RD mode. The scene generation unit 8 generates a piece of scene information stop_pos_reach=1 because the host vehicle 20 has reached the designated position from the external apparatus 15, the pieces of scene information ppl_around_crswlk=0 and ppl_stop=0 because the pedestrian 22 is not present in the crosswalk area, and the piece of scene information ego_stop_frnt_crswlk=1 because the host vehicle 20 is stopped in front of the crosswalk area.

The first mode calculation unit 9a performs transition of (a23) because the transition equation “stop_pos_reach==1” is satisfied from the external instruction information, the above-mentioned pieces of scene information, and the current mode of the first mode calculation unit 9a and outputs the WI mode as a result of calculation.

The second mode calculation unit 9b remains in the same RD mode because the transition conditions of the transition numbers (b1) and (b2) are not satisfied from the above-mentioned pieces of scene information and the current mode of the second mode calculation unit 9b. That is to say, the second mode calculation unit 9b outputs the RD mode as a result of calculation.

The mode selection unit 10 selects the WI mode (waiting for the instruction) calculated by the first mode calculation unit 9a and outputs the selected WI mode as the action of the host vehicle 20 because the WI mode is the mode to address the risk that can occur due to the obstacle compared with the RD mode (road following travel) calculated by the second mode calculation unit 9b.

In FIG. 16, the time t3 represents a state of the pedestrian 22 entering the crosswalk area while the host vehicle 20 is waiting for an instruction from the external apparatus 15. As shown in FIG. 20, the last modes of the first mode calculation unit 9a and the second mode calculation unit 9b at the time t3 are respectively the WI mode and the RD mode. The current modes of the first mode calculation unit 9a and the second mode calculation unit 9b at the time t3 are respectively the WI mode and the RD mode. The scene generation unit 8 generates the piece of scene information stop_pos_reach=1 because the host vehicle 20 is stopped while reaching the designated position from the external apparatus 15 and does not newly receive the designated position, the piece of scene information ppl_around_crswlk=1 because the pedestrian 22 is present in the crosswalk area, the piece of scene information ppl_stop=0 because the pedestrian 22 in the crosswalk area is moving, and the piece of scene information ego_stop_frnt_crswlk=1 because the host vehicle 20 is stopped in front of the crosswalk area as at the time t2.

The first mode calculation unit 9a remains in the same WI mode because transition conditions of the transition numbers (a19), (a20), and (a21) are not satisfied from the external instruction information, the above-mentioned pieces of scene information, and the current mode of the first mode calculation unit 9a.

The second mode calculation unit 9b performs transition of the transition number (b1) because the transition equation “ppl_around_crswlk==1” is satisfied from the above-mentioned pieces of scene information and the current mode of the second mode calculation unit 9b and outputs the SC mode as a result of calculation.

The mode selection unit 10 selects the WI mode (waiting for the instruction) calculated by the first mode calculation unit 9a and outputs the selected WI mode as the action of the host vehicle 20 because the WI mode is the mode to address the risk that can occur due to the obstacle compared with the SC mode (stop in front of the crosswalk) calculated by the second mode calculation unit 9b.

In FIG. 16, the time t4 represents a state of the pedestrian 22 having entered the crosswalk area stopping while the host vehicle 20 is waiting for the instruction from the external apparatus 15. As shown in FIG. 20, the last modes of the first mode calculation unit 9a and the second mode calculation unit 9b at the time t4 are respectively the WI mode and the SC mode. The current modes of the first mode calculation unit 9a and the second mode calculation unit 9b at the time t4 are respectively the WI mode and the SC mode. The scene generation unit 8 generates the piece of scene information stop_pos_reach=1 because the host vehicle 20 is stopped while reaching the designated position from the external apparatus 15 and does not newly receive the designated position, the piece of scene information ppl_around_crswlk=1 because the pedestrian 22 is present in the crosswalk area, the piece of scene information ppl_stop=1 because the pedestrian 22 in the crosswalk area stops, and the piece of scene information ego_stop_frnt_crswlk=1 because the host vehicle 20 is stopped in front of the crosswalk area as at the time t3.

The first mode calculation unit 9a remains in the same WI mode because the transition conditions of the transition numbers (a19), (a20), and (a21) are not satisfied from the external instruction information, the above-mentioned pieces of scene information, and the current mode of the first mode calculation unit 9a.

The second mode calculation unit 9b performs transition of the transition number (b4) because the transition equation “ego_stop_frnt_crswlk==1&&ppl_stop==1” is satisfied from the above-mentioned pieces of scene information and the current mode of the second mode calculation unit 9b and outputs the WC mode as a result of calculation.

The mode selection unit 10 selects the WI mode (waiting for the instruction) calculated by the first mode calculation unit 9a and outputs the selected WI mode as the action of the host vehicle 20 because the WI mode is the mode to address the risk that can occur due to the obstacle compared with the WC mode (crossing intention check) calculated by the second mode calculation unit 9b.

In FIG. 16, the time t5 represents a state of the host vehicle 20 slowly traveling in the crosswalk area to pass through the crosswalk area because the pedestrian 12 still stops in the crosswalk area while the host vehicle 20 is waiting for the instruction from the external apparatus 15 from the time t=t4 to t5. The external instruction acquisition unit 11 acquires the external instruction information indicating resumption of driving from the designated position from the controller. As shown in FIG. 20, the last modes of the first mode calculation unit 9a and the second mode calculation unit 9b at the time t5 are respectively the WI mode and the WC mode. The current modes of the first mode calculation unit 9a and the second mode calculation unit 9b at the time t5 are respectively the WI mode and the WC mode. The scene generation unit 8 generates the piece of scene information stop_pos_reach=0 because the host vehicle 20 has newly received the external instruction information, the pieces of scene information ppl_around_crswlk=1 and ppl_stop=1 because ppl_around_crswlk and ppl_stop are similar to those in the scene at the time t4, and the piece of scene information ego_stop_frnt_crswlk=0 because the host vehicle 20 is traveling.

The first mode calculation unit 9a performs transition of the transition number (a19) because the transition condition of the transition number (a19) is satisfied from the external instruction information, the above-mentioned pieces of scene information, and the current mode of the first mode calculation unit 9a and outputs the LF mode as a result of calculation.

The second mode calculation unit 9b performs transition of the transition number (b7) because the transition equation “prev_mode2(i)==WC, i==within a period of time set in advance” is satisfied from the above-mentioned pieces of scene information and the current mode of the second mode calculation unit 9b over the period of time set in advance. The transition equation is considered in a similar manner to that described with reference to FIG. 11 in Embodiment 1.

The mode selection unit 10 selects the CCC mode (slow travel near the crosswalk) calculated by the second mode calculation unit 9b and outputs the selected CCC mode as the action of the host vehicle 20 because the CCC mode is the mode to address the risk that can occur due to the obstacle compared with the LF mode (path following) calculated by the first mode calculation unit 9a.

In FIG. 16, the time t6 represents a state of the host vehicle 20 having passed through the crosswalk. As shown in FIG. 20, the last modes of the first mode calculation unit 9a and the second mode calculation unit 9b at the time t6 are respectively the LF mode and the CCC mode. The current modes of the first mode calculation unit 9a and the second mode calculation unit 9b at the time t6 are respectively the LF mode and the CCC mode. The scene generation unit 8 generates the piece of scene information stop_pos_reach=0 because stop_pos_reach is similar to that in the scene at the time t5, the pieces of scene information ppl_around_crswlk=0 and ppl_stop=0 because the crosswalk area falls outside the scene calculation area, and the piece of scene information ego_stop_frnt_crswlk=0 because the host vehicle 20 is traveling.

The first mode calculation unit 9a remains in the same LF mode because transition conditions of the transition numbers (a22) and (a3) are not satisfied from the external instruction information, the above-mentioned pieces of scene information, and the current mode of the first mode calculation unit 9a.

The second mode calculation unit 9b performs transition of the transition number (b8) because the transition equation “ppl_around_crswlk==0” is satisfied from the above-mentioned pieces of scene information and the current mode of the second mode calculation unit 9b and outputs the RD mode as a result of calculation.

The mode selection unit 10 selects the LF mode (path following) calculated by the first mode calculation unit 9a and outputs the selected LF mode as the action of the host vehicle 20 because the LF mode is the mode to address the risk that can occur due to the obstacle compared with the RD mode (road following travel) calculated by the second mode calculation unit 9b.

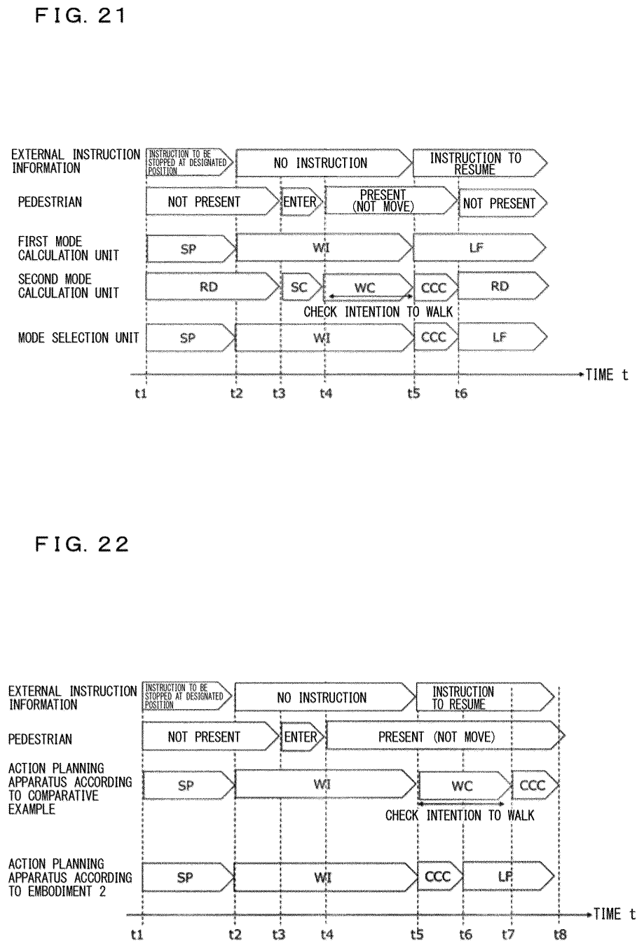

Effects of the action planning apparatus 1 according to the present embodiment will be described next with reference to FIGS. 21 and 22. FIG. 21 is a diagram showing operation of the action planning apparatus 1 according to Embodiment 2 in a time sequence. FIG. 22 is a diagram showing operation of an action planning apparatus according to a comparative example of Embodiment 2 in a time sequence. FIG. 21 shows a flow of operation of the action planning apparatus 1 shown in FIGS. 16 and 20 in a time sequence. The times t1 to t6 in FIGS. 21 and 22 match the times t1 to t6 shown in FIGS. 16 and 20.

When the plurality of pieces of scene information are generated, the plurality of mode calculation units 9 according to Embodiment 2 calculate the plurality of modes in parallel. In the present embodiment, the example in which the mode calculation unit 9 includes the first mode calculation unit 9a and the second mode calculation unit 9b, and the first mode calculation unit 9a and the second mode calculation unit 9b calculate the modes in parallel when the plurality of pieces of scene information are generated has been shown.

As shown in FIG. 21, the action planning apparatus 1 according to Embodiment 2 checks the intention to walk of the pedestrian 22 using the second mode calculation unit 9b from the time t4 to the time t5. This enables the host vehicle 20 to pass by slow travel while recognizing the pedestrian 22 present near the crosswalk when acquiring the external instruction information indicating resumption from the external apparatus 15 at the time t5.

In contrast, the mode calculation unit of the action planning apparatus according to the comparative example shown in FIG. 22 is a single mode calculation unit. That is to say, the mode calculation unit of the action planning apparatus according to the comparative example cannot calculate the plurality of modes in parallel when the plurality of pieces of scene information are generated. The single mode calculation unit of the action planning apparatus according to the comparative example outputs one mode considered to be the safest using one or more pieces of scene information. FIG. 22 shows operation of the action planning apparatus according to the comparative example in a time sequence as for an operational scenario of the pedestrian 22 and the external instruction illustrated in FIG. 16. In FIG. 22, a result of output of the mode calculation unit of the action planning apparatus according to Embodiment 2 shown in FIG. 21 is shown to be superimposed for comparison between operation of the action planning apparatus 1 according to Embodiment 2 and operation of the action planning apparatus according to the comparative example.

As shown in FIG. 22, the action planning apparatus according to the comparative example is stopped not to check the intention to walk of the pedestrian 22 but to wait for the instruction from the external apparatus 15 from the time t4 to the time t5. Thus, when the action planning apparatus according to the comparative example acquires the external instruction information indicating resumption from the external apparatus 15 at the time t5, the single mode calculation unit starts checking the intention to walk from the time t5 because the external instruction to resume might be output without taking information on the pedestrian 22 into consideration. That is to say, the action planning apparatus according to the comparative example causes the host vehicle 20 to be stopped at the intersection for a longer time and to take more conservative action than the action planning apparatus 1 according to Embodiment 2.

As described above, operation of the action planning apparatus 1 according to the present embodiment that can calculate the modes in parallel using the plurality of mode calculation units 9 and operation of the action planning apparatus 1 according to Comparative Example 1 that includes the single mode calculation unit 9 respectively include slow travel from the time t5 and slow travel from the time t7 and differ in stop time when a time to check the intention to walk is similarly secured.

The action planning apparatus 1 according to the present embodiment calculates, when the plurality of pieces of scene information are generated by the scene generation unit 8, the plurality of modes in parallel using the plurality of pieces of scene information and selects one of the modes calculated in the calculating step and outputs the selected one of the modes as the action of the host vehicle 20. Conservative action can thereby be avoided in a composite scene.

The scene generation unit 8 generates the one or more pieces of scene information using the surroundings information and the external instruction information being information indicating an instruction on driving of the host vehicle 20 from the external apparatus 15, and the mode calculation unit 9 calculates the modes using the external instruction information and the one or more pieces of scene information. The action planning apparatus 1 according to the present embodiment can thus avoid conservative action in a composite scene involving the instruction from the external apparatus 15 compared with the action planning apparatus according to the comparative example.

### Embodiment 3

An action planning apparatus 1 according to Embodiment 3 will be described. As described above, when the plurality of mode calculation units 9 calculate the plurality of different modes, the mode selection unit 10 selects one of the plurality of modes calculated by the plurality of mode calculation units 9 using degrees of priority of the modes set in advance and outputs the selected one of the modes as the action of the host vehicle 20. An example in which the degrees of priority are set to give priority to the mode to address the obstacle, for example, has been described in Embodiment 1. Embodiment 3 differs from Embodiment 1 in how the mode selection unit 10 sets the degrees of priority. The other configuration of the action planning apparatus 1 is the same as that of the action planning apparatus 1 according to Embodiment 1 or Embodiment 2.

As described above, each mode calculated by the mode calculation unit 9 is information indicating at least one of the target path, the target speed, and the target position.

The mode selection unit 10 holds degrees of priority set in advance to give priority to a mode having a lower target speed. When the plurality of mode calculation units 9 calculate the plurality of different modes, the mode selection unit 10 selects one of the plurality of modes calculated by the plurality of mode calculation units 9 using the degrees of priority of the modes set in advance and outputs the selected one of the modes as the action of the host vehicle 20. For example, when a result of calculation of the first mode calculation unit 9a is the CI mode (travel intersection at a recommended vehicle speed) and a result of calculation of the second mode calculation unit 9b is the CCC mode (slow travel near the crosswalk), the mode selection unit 10 outputs the CCC mode having a lower target speed as the action of the host vehicle 20.

The mode selection unit 10 may not only set the degrees of priority to give priority to the mode having a lower target speed but also set the degrees of priority in combination to give priority to the mode to address the obstacle.

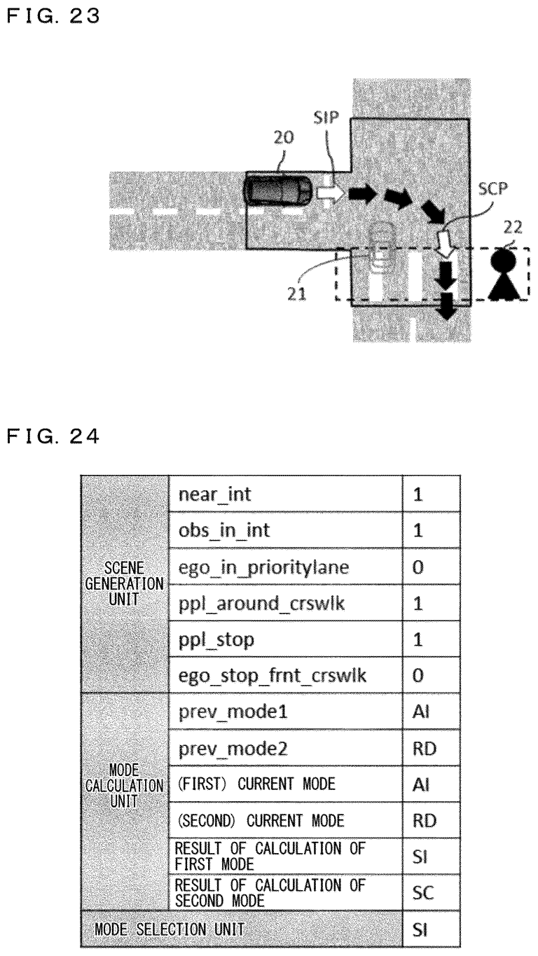

The mode selection unit 10 may also hold degrees of priority set in advance to give priority to a mode having a smaller distance from a current position to a target position of the host vehicle 20. A specific example will be described with reference to FIG. 23. FIG. 23 is a schematic diagram illustrating a situation in which the host vehicle 20 according to Embodiment 3 is placed. FIG. 23 illustrates a scene when a path is planned for the host vehicle 20 to turn right at an intersection, and the host vehicle 20 waits for the other vehicle 21 in the intersection to pass and takes the pedestrian 22 present in the crosswalk area into consideration during travel. In FIG. 23, arrows indicate the path, a range indicated in a solid line is an intersection area, and a range indicated in a broken line is a crosswalk area.

As in Embodiment 1, the scene generation unit 8 generates a result of determination made using the obstacle information and the road information described above as the one or more pieces of scene information as shown in FIG. 5. The first mode calculation unit 9a and the second mode calculation unit 9b are similar to those described with reference to FIGS. 6 to 9 in Embodiment 1.

FIG. 24 is a diagram showing examples of results of output of the respective components of the action planning apparatus 1 according to Embodiment 3. Assume that the last modes of the first mode calculation unit 9a and the second mode calculation unit 9b at a time shown in FIG. 23 are respectively the AI mode and the RD mode. Similarly, assume that the current modes of the first mode calculation unit 9a and the second mode calculation unit 9b are respectively the AI mode and the RD mode. The scene generation unit 8 generates, using the surroundings information acquired by the surroundings information acquisition unit 2, the piece of scene information near_int=1 because the host vehicle 20 is present in the intersection area, the piece of scene information obs_in_int=1 because the other vehicle 21 is present in the intersection area, the piece of scene information ego_in_prioritylane=0 because the lane in which the host vehicle 20 is traveling is the non-priority road, the pieces of scene information ppl_around_crswlk=1 and ppl_stop=1 because the pedestrian 22 is present in the crosswalk area and stops, and the piece of scene information ego_stop_frnt_crswlk=0 because the host vehicle 20 is stopped but is at a position away from a crosswalk CWA.

The first mode calculation unit 9a performs transition of the transition number (a7) because the transition equation “obs_in_int==1|ego_in_prioritylane==0” is satisfied from the above-mentioned pieces of scene information and the current mode of the first mode calculation unit 9a and outputs the SI mode as a result of calculation. Assume that the target position of the SI mode is a position on the stop line.

The second mode calculation unit 9b performs transition of the transition number (b1) because the transition equation “ppl_around_crswlk==1” is satisfied from the above-mentioned pieces of scene information and the current mode of the second mode calculation unit 9b and outputs the SC mode as a result of calculation. Assume that the target position of the SC mode is a position in front of the crosswalk area.

The mode selection unit 10 compares the target positions of the modes calculated by the first mode calculation unit 9a and the second mode calculation unit 9b. That is to say, the first mode calculation unit 9a outputs the SI mode, so that the target position is a position on the stop line in the intersection area. The mode selection unit 10 thus calculates a point SIP on the planned path. The second mode calculation unit 9b outputs the SC mode, so that the target position is a position in front of the crosswalk area. That is to say, the mode selection unit 10 calculates a point SCP on the planned path. The mode selection unit 10 outputs the SI mode having a smaller distance from the current position to the target position of the host vehicle 20 on the path as the action of the host vehicle 20. In a setting method according to Embodiment 1, the mode to address the obstacle is set preferentially, so that the SC mode derived from the pedestrian on a side of the crosswalk might be selected. On the other hand, in Embodiment 3, the mode having a smaller distance from the current position to the target position of the host vehicle 20 is set preferentially, so that the SI mode, which is a more appropriate mode, is selected. The mode selection unit 10 can thereby set the degrees of priority to output safer action.

The mode selection unit 10 may not only set the degrees of priority to give priority to the mode having a smaller distance from the current position to the target position of the host vehicle 20 but also set the degrees of priority in combination to give priority to the mode to address the obstacle. Furthermore, the mode selection unit 10 may not only set the degrees of priority to give priority to the mode having a smaller distance from the current position to the target position of the host vehicle 20 but also set the degrees of priority in combination to give priority to the mode having a lower target speed and the mode to address the obstacle.

The action planning apparatus 1 according to the present embodiment calculates, when the plurality of pieces of scene information are generated by the scene generation unit 8, the plurality of modes in parallel using the plurality of pieces of scene information and selects one of the modes calculated in the calculating step and outputs the selected one of the modes as the action of the host vehicle 20. Conservative action can thereby be avoided in a composite scene.

When the plurality of mode calculation units 9 calculate the plurality of different modes, the mode selection unit 10 selects one of the plurality of modes calculated by the plurality of mode calculation units 9 using the degrees of priority of the modes set in advance and outputs the selected one of the modes as the action of the host vehicle 20. The mode selection unit 10 holds the degrees of priority set in advance to give priority to the mode having a lower target speed. The mode selection unit 10 may also hold the degrees of priority set in advance to give priority to the mode having a smaller distance from the current position to the target position of the host vehicle 20. Safer and optimal action of the host vehicle 20 can thereby be planned in a composite scene.

While an example in which the action planning apparatus 1 plans action of the host vehicle 20 has been described in the present description, application is not limited to application to the vehicle but may be application to various moving bodies. The action planning apparatus 1 can be used as an apparatus that plans action of a moving body, such as an in-building moving robot that inspects the interior of a building, a line inspection robot, and a personal transporter. When the moving body is other than the host vehicle 20, the map acquisition unit 7 of the road information detection unit 6 acquires a travelable region on a path along which the moving body travels as map data, for example. Embodiments of the present invention can freely be combined with each other and can be modified or omitted as appropriate within the scope of the present invention.

### EXPLANATION OF REFERENCE SIGNS

1 action planning apparatus, 2 surroundings information acquisition unit, 3 obstacle information acquisition unit, 4 obstacle information detection unit, 5 road information acquisition unit, 6 road information detection unit, 7 map acquisition unit, 8 scene generation unit, 9 mode calculation unit, 9a first mode calculation unit, 9b second mode calculation unit, 10 mode selection unit, 11 external instruction acquisition unit, 12 processing circuit, 13 processor, 14 memory, 15 external apparatus, 20 host vehicle, 21 another vehicle, 22 pedestrian

1.-10. (canceled)

11. An action planning apparatus comprising:
scene generation circuitry to generate, using surroundings information on surroundings of a moving body, one or more pieces of scene information indicating a situation in which the moving body is placed;
mode calculation circuitry to calculate, in parallel, a plurality of modes as candidates for action that the moving body can take using the one or more pieces of scene information; and
mode selection circuitry to select one of the modes calculated by the mode calculation circuitry and output the selected one of the modes as action of the moving body.

12. The action planning apparatus according to claim 11, wherein
the mode calculation circuitry calculates the modes using the one or more pieces of scene information and a current mode of the mode calculation circuitry.

13. The action planning apparatus according to claim 11, wherein
the mode calculation circuitry calculates the modes using the one or more pieces of scene information and a previous mode of the mode calculation circuitry.

14. The action planning apparatus according to claim 11, wherein
the mode calculation circuitry is at least one of a FSM, a neural network, and ontology.

15. The action planning apparatus according to claim 11, wherein
the mode selection circuitry selects, using degrees of priority of the modes set in advance, one of the modes calculated by the mode calculation circuitry and outputs the selected one of the modes as the action of the moving body.

16. The action planning apparatus according to claim 15, wherein
the degrees of priority are set to give priority to a mode to address an obstacle present around the moving body.

17. The action planning apparatus according to claim 15, wherein
the degrees of priority are set to give priority to a mode having a lower target speed.

18. The action planning apparatus according to claim 15, wherein
the degrees of priority are set to give priority to a mode having a smaller distance from a current position to a target position of the moving body.

19. The action planning apparatus according to claim 11, wherein
the scene generation circuitry generates the one or more pieces of scene information using the surroundings information and external instruction information being information indicating an external instruction on driving of the moving body, and
the mode calculation circuitry calculates the modes using the external instruction information and the one or more pieces of scene information.

20. An action planning apparatus comprising:
scene generation circuitry to generate, using surroundings information on surroundings of a moving body, one or more pieces of scene information indicating a situation in which the moving body is placed;
mode calculation circuitry to calculate, when one piece of scene information is generated by the scene generation circuitry, one or more modes as candidates for action that the moving body can take using the one piece of scene information and calculate, when a plurality of pieces of scene information are generated by the scene generation circuitry, a plurality of modes as candidates for action that the moving body can take in parallel using the plurality of pieces of scene information; and
mode selection circuitry to select one of the modes calculated by the mode calculation circuitry and output the selected one of the modes as action of the moving body.

21. The action planning apparatus according to claim 20, wherein
the mode calculation circuitry calculates the modes using the one or more pieces of scene information and a current mode of the mode calculation circuitry.

22. The action planning apparatus according to claim 20, wherein
the mode calculation circuitry calculates the modes using the one or more pieces of scene information and a previous mode of the mode calculation circuitry.

23. The action planning apparatus according to claim 20, wherein
the mode calculation circuitry is at least one of a FSM, a neural network, and ontology.

24. The action planning apparatus according to claim 20, wherein
the mode selection circuitry selects, using degrees of priority of the modes set in advance, one of the modes calculated by the mode calculation circuitry and outputs the selected one of the modes as the action of the moving body.

25. The action planning apparatus according to claim 24, wherein
the degrees of priority are set to give priority to a mode to address an obstacle present around the moving body.

26. The action planning apparatus according to claim 24, wherein
the degrees of priority are set to give priority to a mode having a lower target speed.

27. The action planning apparatus according to claim 24, wherein
the degrees of priority are set to give priority to a mode having a smaller distance from a current position to a target position of the moving body.

28. The action planning apparatus according to claim 20, wherein
the scene generation circuitry generates the one or more pieces of scene information using the surroundings information and external instruction information being information indicating an external instruction on driving of the moving body, and
the mode calculation circuitry calculates the modes using the external instruction information and the one or more pieces of scene information.

29. An action planning method comprising:
generating, using surroundings information on surroundings of a moving body, one or more pieces of scene information indicating a situation in which the moving body is placed;
calculating a plurality of modes as candidates for action that the moving body can take in parallel using the one or more pieces of scene information; and
selecting one of the modes calculated in the calculating and outputting the selected one of the modes as action of the moving body.
